(19) United States
(12) Patent Application Publication
(10) Pub. No.: US 2002/0108104 A1
(43) Pub. Date: Aug. 8, 2002

(54) Certification and manual compiling wizard

(76) Inventors: Xueshu Song, DeKalb, IL (US); Clifford Mirman, DeKalb, IL (US)

Correspondence Address: KOHN & ASSOCIATES, Suite 410, 30500 Northwestern Highway, Farmington Hills, MI, 48334, US

(21) Appl. No.: 09/951,223

(22) Filed: Sep. 13, 2001

Related U.S. Application Data
(60) Provisional application No. 60/232,464, filed on Sep. 13, 2000.

(51) Int. Cl. G06F 9/45

(52) U.S. Cl. 717/140

(57) ABSTRACT

According to the present invention, there is provided a compiling wizard including a storage and creation mechanism for compiling information, data, documents, and media and a user viewer mechanism for viewing and accessing the compiled information, data, documents, and media. The present invention aids a user in any type of certification or manual compiling process. Further, the present invention allows a user to efficiently sort, store, and access all types of information, data, documents, and media. The present invention further provides for a standardized tracking mechanism for naming, traversing, updating, and archiving files of variable formats. The present invention also includes a software program for controlling and operating the compiling wizard and all of its functions.

### CROSSREFERENCE TO RELATED APPLICATIONS

This application claims the benefit of priority under 35 U.S.C. Section 119(e) of U.S. Provisional Patent Application No. 60\232,464, filed Sep. 13, 2000, which is incorporated herein by reference.

### BACKGROUND OF THE INVENTION

1. FIELD OF THE INVENTION

The present invention relates to a certification and manual compiling wizard. More specifically, the present invention relates to a certification and manual compiling wizard for creating a standardized file structure builder and viewer.

2. DESCRIPTION OF RELATED ART

There are numerous software programs and computer databases currently existing that store various quantitative information such as word processing documents, images, and audio media. With the increasing complexity of today's working society, a large number and types of documents have been and continue to be generated. These documents exist for many processes such as accreditation, presentation, and documentation. As a result, the documents need to be organized in a fashion that allows individuals to efficiently store and obtain the information stored and located on a computer or networked system.

Although there are currently existing software programs that aid individuals and companies in organizing various documents into folders and other formats, there is no practical software that allows individuals to efficiently store information on the computer. More specifically, there is no software program that provides for a front-end mechanism that stores and sorts all types of information, data, documents, and media.

### SUMMARY OF THE INVENTION

According to the present invention, there is provided a compiling wizard including a storage and creation mechanism for compiling information, data, documents, and media and a user viewer mechanism for viewing and accessing the compiled information, data, documents, and media. The present invention aids a user in any type of certification or manual compiling process. Further, the present invention allows a user to efficiently sort, store, and access all types of information, data, documents, and media. The present invention further provides for a standardized tracking mechanism for naming, traversing, updating, and archiving files of variable formats. The present invention also includes a software program for controlling and operating the compiling wizard and all of its functions.

### DESCRIPTION OF THE DRAWINGS

Other advantages of the present invention will be readily appreciated, as the same becomes better understood by reference to the following detailed description when considered in connection with the accompanying drawings wherein:

FIG. 1 is a view of one embodiment of the present invention, specifically a file storage and creation system interface for setting up a file structure;

FIG. 2 is a view of an embodiment of the present invention, specifically the file storage and creation system interface prompting screen that allows a system manager to select a new or existing project;

FIG. 3 is a view of an embodiment of the present invention, specifically an interface screen of a new project icon of the user system of the present invention;

FIG. 4 is a view of an embodiment of the present invention, specifically a set-up interface screen used by a system manager for a new project of the file storage and creation system;

FIG. 5 is a view of an embodiment of the present invention displaying a file folder created under the file storage and creation system, wherein the file folder is entitled “Temp_comp_wiz” and is in the base directory of the “C:” or hard drive;

FIG. 6 is a view of an embodiment of the present invention illustrating an archive directory located within the “Temp_comp_wiz” directory, wherein all modified files are placed in a similar structure;

FIG. 7 is a view of an embodiment of the present invention wherein the computer wizard file structure system of the present invention is shown through an interface screen;

FIG. 8 is a detailed view of an embodiment of the present invention of the computer wizard file structure system illustrating various features through an interface screen;

FIG. 9 is a detailed view of an embodiment of the present invention of the computer wizard file structure system illustrating various features through an interface screen;

FIG. 10 is a detailed view of an embodiment of the present invention of a selected computer wizard file structure system illustrating access to a file format through the interface screen;

FIG. 11 is a view of an embodiment of the present invention of a user viewer system displaying an initial general user viewer interface welcome screen;

FIG. 12 is a view of an embodiment of the present invention of a user viewer interface screen;

FIG. 13 is a view of an embodiment of the present invention of an instruction screen of the user viewer system; and

FIG. 14 is a view of an embodiment of the present invention of an interface screen of the user viewer system, wherein the various information is archived and stored.

### DETAILED DESCRIPTION OF THE INVENTION

Generally, the present invention provides for a compiling wizard that utilizes a computer-user interface, which guides both the building of a file structure and accessing and viewing of the file structure and associated processes. Additionally, the present invention provides for a certification and manual compiling wizard for use in standardized file naming, traversal, updating, and archiving via an auxiliary file tracking system for variable file formats. More specifically, the present invention further provides for a computer software program that controls and operates the compiling wizard. The software program allows any user to document and create a naming structure for files with variable formats based upon the user's set criteria and/or qualifications.

The present invention aids a user in any certification or manual compiling process. The present invention overcomes prior art systems by providing a far less time consuming and virtually error free system and method of sorting, storing, and accessing various compiled information.

The term “standardized file naming” as used herein, is meant to include, but is not limited to, a system that organizes all documents under a standardized file structure according to a specific certification and manual compiling standard. Examples of such compiling standards include, but are not limited to, ISO 9000, ABET, NAIT and any other situations where a large number of files are under variable formats that need to be organized and traversed into a standardized naming system.

The term “file traversal” as used herein, is meant to include, but is not limited to, computerized documents, in any format that can be viewed during runtime via guided traversal of the file structure during certification and manual review processes.

The term “updating and archiving” as used herein, is meant to include, but is not limited to, the process of updating files by replacing the most current file with existing files. The files being replaced are automatically archived and time stamped.

The term “information” as used herein, is meant to include, but is not limited to, any text, spreadsheet, numerical data, documents, data, video files, audio files, graphics, media, images, and any other information that can be stored on a computer or networked system known to those of skill in the art.

The compiling wizard of the present invention can be used in any number of settings and fields. Generally, the present invention is useful where a large number of files under variable formats need to be organized and traversed into a standard naming system. The present invention is utilized in numerous settings and fields including, health care, law, engineering, accounting, business and any other fields that can utilize a compiling wizard as described herein.

The compiling wizard of the present invention includes two major functions. The first function is as a guide for a user (“Builder”) to compile information or various files with various file names and types from various locations within the computer file system into a single “complied file system.” This allows for a portable system that can be easily archived and retrieved for any specific purpose and/or process (i.e., ISO 9000 certification).

Another function of the present invention allows for the presentation of files that are compiled in accordance with the first function within the same file structure. These files can be automatically archived during file updates. The key for implementation of the present invention is the use of an “auxiliary file system” or “file of file” system in which each file is created, updated, and retrieved during both functions of the present invention to store: (1) a “virtual file name” that is used for both compiling and viewing a file and (2) the file type that is needed for the software to display a file in the second function of the present invention.

The underlying principle of the compiling wizard of the present invention is the simplicity with which a virtual file cabinet can be developed and utilized by any user. The present invention can be used to create a storage and retrieval system for any type of computer file and/or program. For example, the present invention can be used for text documents, numerical information, video media, audio media, graphical media, pictures, and any other similar media, data, or information known to those of skill in the art. Additionally, the present invention can be used with any type of computer system and uses any file location that the user deems appropriate or designates. Thus, the user can group all of the created and stored files in any location on the computer hard drive. This allows for easy removal and backup as well as the ability to locate and use the files.

The compiling wizard of the present invention includes two systems or mechanisms: (1) a file storage and creation system or mechanism and (2) a user viewer system or mechanism. The file storage and creation system is controlled by a software program that allows a system manager to create the overall structure and add the files as needed. In addition, the compiling wizard allows for archival and back-up of the files that are updated and altered. The changes are tracked actively and recorded for later inspection.

As for the user viewer system of the compiling wizard, it is controlled by a software program that allows any system user, either at a local station or at a remote station, to have read only access to the original files in the system. The simplicity of the system allows the user to be on the same computer as the system manager, a computer down the hall, or in a different city or country.

In general, due to the design of the compiling wizard of the present invention, it can be used by two sets of individuals: (1) a system manager and (2) a system end-user. As previously described, the system manager operates the present invention through a storage and creation mechanism that allows the system manager to set-up the file system and store the basic files and data into the sub areas. Included in the storage and creation mechanism is a sorting mechanism for sorting information into various sub-categories and a standardized file naming mechanism for naming files.

As for a system end-user, the user viewing mechanism allows for any user to access all of the files and/or information compiled by the system manager into the computer or networked system. The user viewing mechanism further includes a tracking mechanism for naming, traversal, updating, and archiving the compiled and entered information from accessible files of variable formats. Although the end-user typically can not change and/or add additional information, such an option is possible if desired. Thus, any changes that are saved are archived for later knowledge and retrieval.

In an embodiment of the present invention, the compiling wizard is installed from a CD ROM. Two files are set-up on the base directory level of the hard drive—the file storage and creation system and the user viewer system. These folders can be given any name, and the third file, Comp_wiz, is set up by the system manager to hold the stored files.

In an embodiment of the present invention, the system manager can distribute the entire file storage and creation system and all of the associated files that are stored. These files can be of any type and/or size. The distribution can be through many storage forms that include, but are not limited to, Zip disks, computer disks, CD-ROM, RAM, ROM, and any other similar storage media known to those of skill in the art. In addition, the distribution can be accessed through the Internet, Intranet, Extranet, and any other similar electronic system known to those of skill in the art.

In an embodiment of the present invention, the compiling wizard includes a security or password protection mechanism. The security or password protecting mechanism can be a simple, typed text or numerical password that prevents access to all files and inputted data, information, and media. The security or password protecting mechanism allows for remote users to have full access to all files and the storage system from any computer attached to the Internet, Intranet, Extranet, and any other similar networked system known to those of skill in the art.

The compiling wizard of the present invention operates through a software program. The software program allows for all of the previously described functions. For instance, the software program allows an initial user or system manager to sort and store information and allows any other user to access the initially sorted and stored information. With the software program of the present invention, users are able to enter or input any information into a computer system. The user then can identify each of the inputted files with an identification tag, which can be subsequently viewed by any user who has access to the computer system from a locally or remotely connected system. The software has been developed for use over the a networked or local system. In addition, the file storage and creation system and user viewer system can be easily loaded onto a CD or other similar media and duplicated and used by many individuals on various computers.

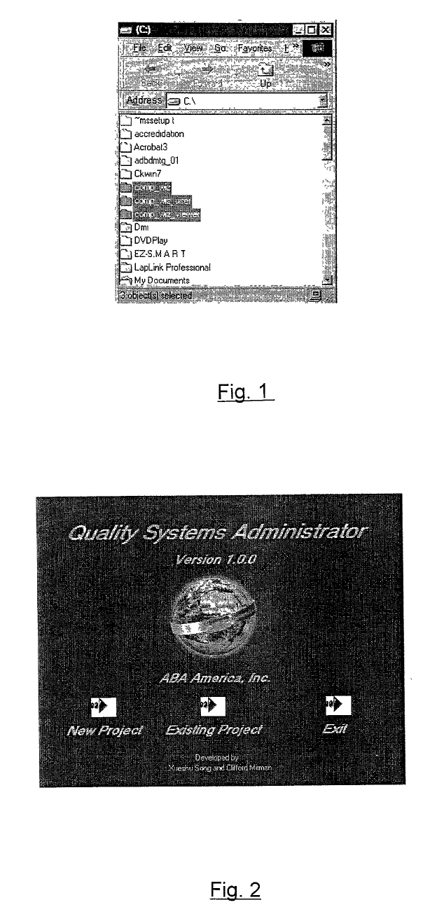

In operation, the storage and creation system of the compiling wizard operates through any variety of steps. In one embodiment, the system manager or initial user sets up the user viewer system through the use of the storage and creation system. This results in creating a virtual filing system. The first step is setting up the file structure (FIG. 1). Then, after using the exe file, the storage and creation system prompts the system manager to select a new or existing project. If the system manager chooses the existing project, the system manager must choose the location of the file folder that contains all of the stored files (FIG. 2).

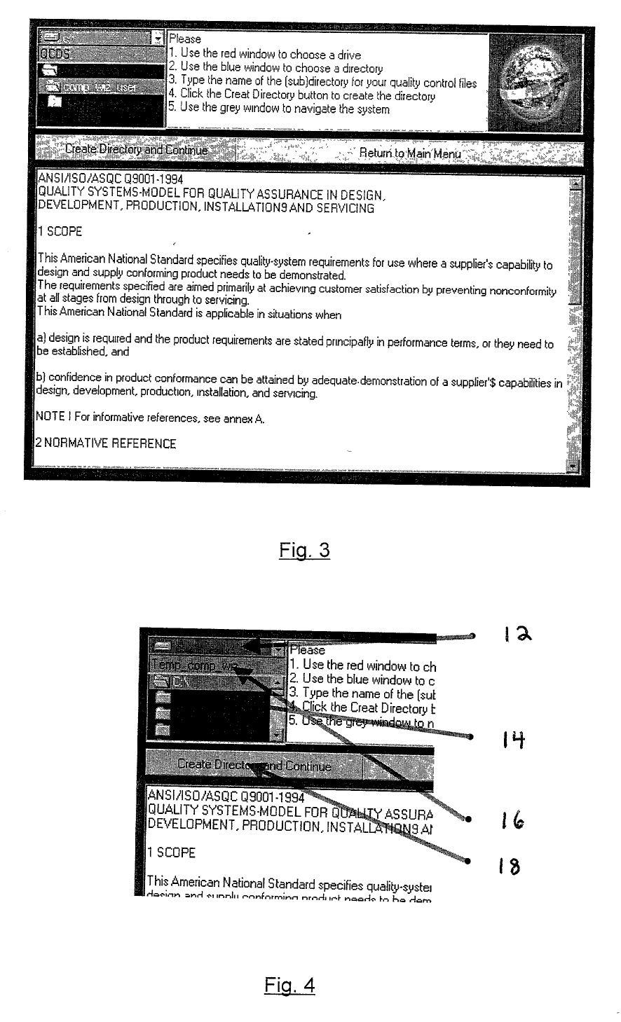

If the system manager chooses a new project icon, then a new project screen appears (FIG. 3). The first step for a new project is to set up the folder storage location (FIG. 4). In order to set up the folder storage location, the location is selected at which the files are stored 12. The system manager first decides on which drive the folder is to be stored. By clicking on the down arrow next to the “c:box,” the user sets the drive.

Then, the system manager chooses a folder location area on the chosen drive 14. By moving the arrow down and clicking on a given folder to place the system, the user can select the location. Then, the root directory is chosen.

Next, the folder name where the system folders are to be stored are entered into the system 16. Afterwards, the “Create Directory and Continue” button is selected and the folder is created at the desired location 18.

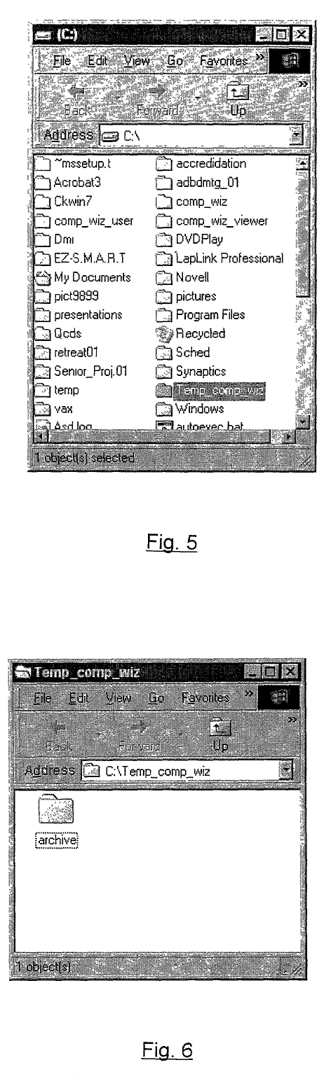

Using this structure shown above places the folder “Temp_comp_wiz” on the base directory of the C:, or hard drive. It is in this area that all of the computer wizard files are to be stored (FIG. 5). Within the “Temp_comp_wiz” directory, there is an archive directory in which all modified files are placed in a similar structure (FIG. 6).

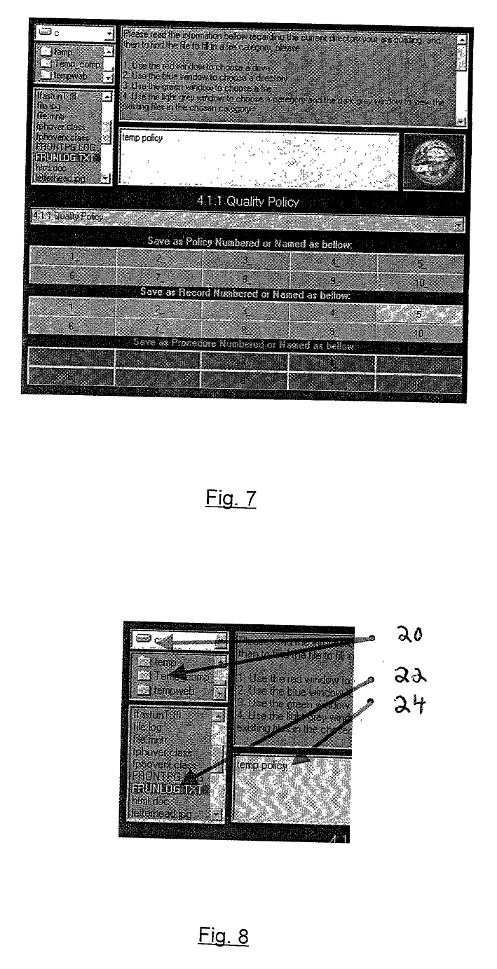

Use of the compiling wizard file structure system or user viewer system of the present invention is shown through an interface screen (FIG. 7). For example, the system is now configured to handle an ISO 9000 file structure. This compiling wizard however, can handle many filing structures in which multiple formats are utilized. All of the files are saved in the “Temp_comp_wiz” folder on the hard drive that was selected earlier. At this point, the goal is to allow the system manager to place the important information, data, and/or media in the correct areas.

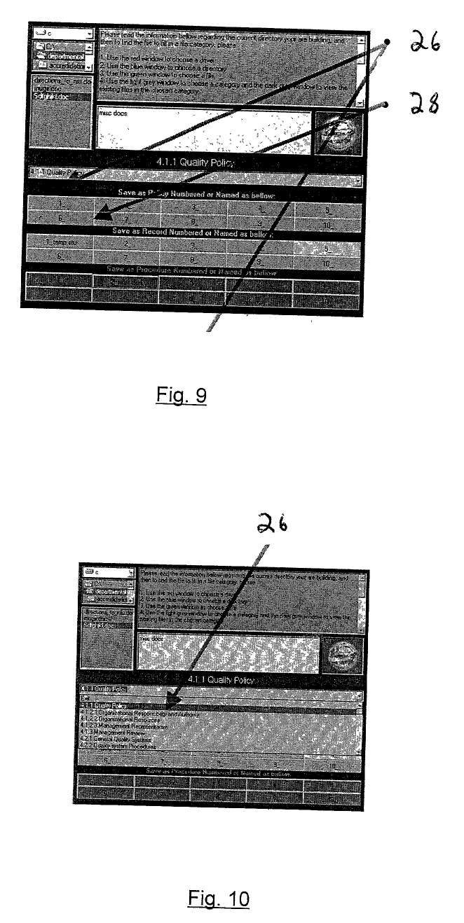

Entering information into the storage and creation system of the compiling wizard is as follows (FIGS. 8, 9, and 10). First, the drive and folder where the stored file should reside is selected 20. Then, the file to store is chosen 22. Next, the title of the file which is to be stored is entered 24. Afterward, the area in which the file is to be saved is selected 26. Finally, the location of the correct folder is selected 28. Once the item is saved in the file location the numerical item location is appended with the title of the file that was saved.

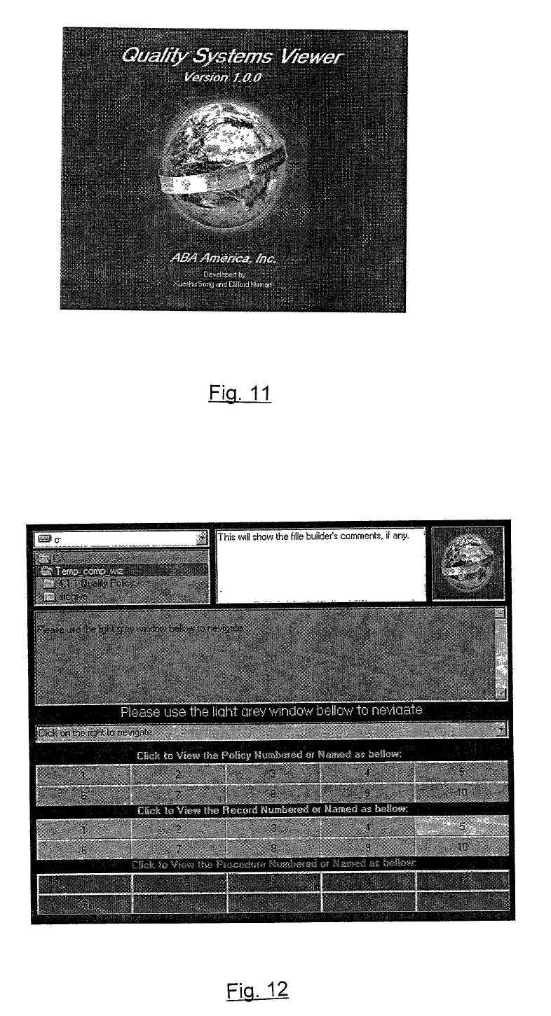

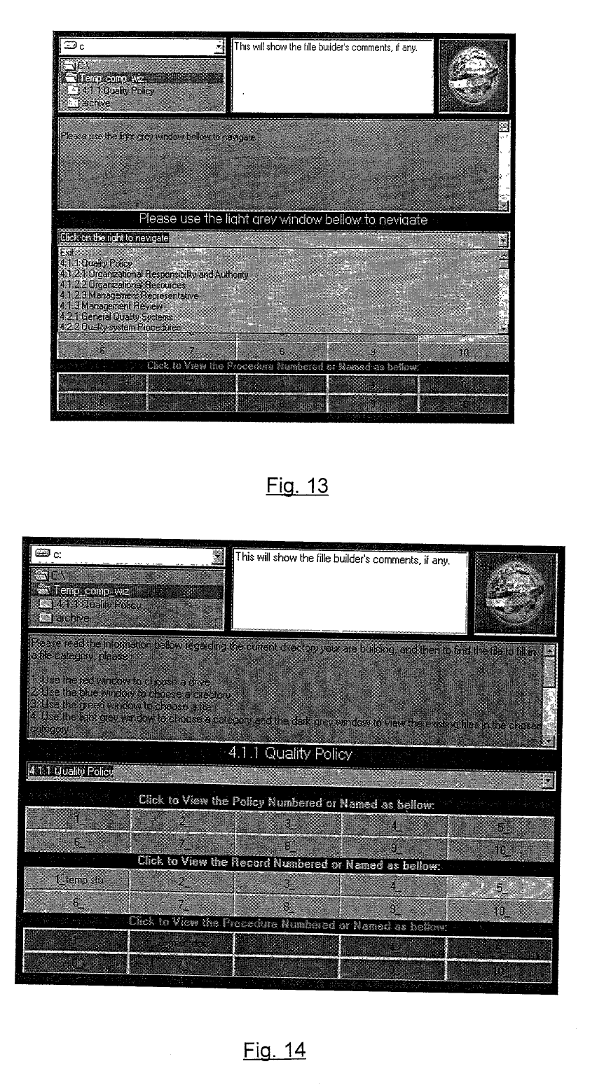

From the user viewer system point of view, the user viewer system utilizes a compiling wizard general user interface (FIG. 11) that welcomes the user and then transitions to the viewer area (FIG. 12). First, as before, the user selects the disk and base file location (FIG. 12). There is no file note in any of the numbered boxes. When one selects an area to view on the gray bar in the middle of the screen, then, the screen prompts the user with instructions (FIG. 13). For instance, when the “4.1.1 Quality Policy” gray window bar is selected, the numbered items are shown with the labels that were generated during the building phase utilizing the storage and creation mechanism (FIG. 14).

In order to operate the present invention, source codes are needed. The present invention can be created through the use of various computing languages or source code languages known to those of skill in the art. While the source code of the present invention is set forth in Visual Basic as described herein, any other computer languages such as C++ can be used without departing from the spirit of the present invention. Additionally, the method of making and function of the compiling wizard of the present invention can be derived from the following source codes. Moreover, any variation from these examples of source codes for various functions of the compiling wizard can occur without departing from the spirit of the present invention.

In one embodiment, the initial builder source code (aba_imec.vbp) is as follows:

Type=Exe

Form=file_blder_1.frm

Reference=*\G{00020430-0000-0000-C000-

000000000046}#2.0#0#..\WINDOWS\SYSTEM\STDOLE2.TLB#OLE

Automation

Form=new_prj.frm

Form=Main.frm

Module=Module1; Module1.bas

Object={3B7C8863-D78F-101B-B9B5-04021C009402}#1.2#0;

RICHTX32.OCX

IconForm=“Form2”

Startup=“Sub Main”

HelpFile=″″

Command32=″″

Name=“Project1”

HelpContextID=“0”

CompatibleMode=“0”

MajorVer=1

MinorVer=0

RevisionVer=0

AutoIncrementVer=0

ServerSupportFiles=0

VersionCompanyName=“NIU”

CompilationType=0

OptimizationType=0

FavorPentiumPro(tm)=0

CodeViewDebugInfo=0

NoAliasing=0

BoundsCheck=0

OverflowCheck=0

FIPointCheck=0

FDIVCheck=0

UnroundedFP=0

StartMode=0

Unattended=0

Retained=0

ThreadPerObject=0

MaxNumberOfThreads=1

In an embodiment, the source code for Version 5.00 of the embodiment illustrated in FIG. 3 (Form 1: new_prj.frm) is as follows:

Begin VB.Form Form1

| | |
|---|---|
| AutoRedraw | = −1 ‘True |
| BackColor | = &H00004000& |
| BorderStyle | = 0 ‘None |
| Caption | = “ANSI/ISO/ASQC Q9001 -1994 1,2,3” |
| ClientHeight | = 6765 |
| ClientLeft | = 4245 |
| ClientTop | = 1920 |
| ClientWidth | = 8430 |
| FillColor | = &H00FFFFFF& |
| LinkTopic | = “Form1” |
| MaxButton | = 0 ‘False |
| MinButton | = 0 ‘False |
| ScaleHeight | = 6765 |
| ScaleWidth | = 8430 |
| ShowInTaskbar | = 0 ‘False |
| StartUpPosition | = 2 ‘CenterScreen |

Begin VB.CommandButton Command1

| | |
|---|---|
| BackColor | = &H00FFFF80& |
| Caption | = “Return to Main Menu” |
| Height | = 375 |
| Left | = 3120 |
| Style | = 1 ‘Graphical |
| TabIndex | = 6 |
| Top | = 1680 |
| Width | = 5175 |

End
Begin VB.TextBox Text3

| | |
|---|---|
| Height | = 1455 |
| Left | = 2040 |
| MultiLine | = −1 ‘True |
| TabIndex | = 5 |
| Text | = “new_prj.frx”:0000 |
| Top | = 120 |
| Width | = 4815 |

End
Begin VB.CommandButton Command2

| | |
|---|---|
| BackColor | = &H00C0C0C0& |
| Caption | = “Create Directory and Continue” |
| Height | = 375 |
| Left | = 120 |
| Style | = 1 ‘Graphical |
| TabIndex | = 4 |
| Top | = 1680 |
| Width | = 3015 |

End
Begin VB.TextBox Text2

| | |
|---|---|
| BackColor | = &H0000FF00& |
| Height | = 285 |
| Left | = 120 |
| TabIndex | = 3 |
| Text | = “QCDS” |
| Top | = 360 |
| Width | = 1935 |

End
Begin VB.TextBox Text1

| | |
|---|---|
| BackColor | = &H00C0FFFF& |
| Height | = 4425 |
| Left | = 120 |
| MultiLine | = −1 ‘True |
| ScrollBars | = 2 ‘Vertical |
| TabIndex | = 2 |
| Text | = “new_prj.frx”:0115 |
| Top | = 2160 |
| Width | = 8175 |

End
Begin VB.DirListBox Dir1

| | |
|---|---|
| BackColor | = &H00FF0000& |
| Height | = 990 |
| Left | = 120 |
| TabIndex | = 1 |
| Top | = 600 |
| Width | = 1935 |

End
Begin VB.DriveListBox Drive1

| | |
|---|---|
| BackColor | = &H000000FF& |
| Height | = 315 |
| Left | = 120 |
| TabIndex | = 0 |
| Top | = 120 |
| Width | = 1935 |

End
Begin VB.Image Image1

| | |
|---|---|
| BorderStyle | = 1 ‘Fixed Single |
| Height | = 1455 |
| Left | = 6840 |
| MouseIcon | = “new_prj.frx”:0AEA |
| MousePointer | = 4 ‘Icon |
| Picture | = “new_prj.frx”:0C3C |
| Stretch | = −1 ‘True |
| ToolTipText | = “Click to Continue” |
| Top | = 120 |
| Width | = 1425 |

End

Attribute VB_Name = “Form1”
Attribute VB_GlobalNameSpace = False
Attribute VB_Creatable = False
Attribute VB_PredeclaredId = True
Attribute VB_Exposed = False
Private Sub Command1_Click()
Form1.Hide
Unload Form1
Load Form3
Form3.Show
End Sub
Private Sub Command2_Click()

On Error GoTo DirError

If Len(Dir1.Path) = 3 Then

MkDir (Dir1.Path & Text2.Text)
MkDir (Dir1.Path & Text2.Text & “\archive”)
Qcdir = Dir1.Path & Text2.Text

Else

MkDir (Dir1.Path & “\” & Text2.Text)

MkDir (Dir1.Path & “\” & Text2.Text & “\archive”)

Qcdir = Dir1.Path & “\” & Text2.Text

End If
Unload Form1
Load Form2
Form1.Hide
Form2.Show
Exit Sub

DirError:

MsgBox (“Directory Exists.”), , _{—}
“Try different name for directory”
Resume Stop Trying

StopTrying:
End Sub
Private Sub Drive1_Change()

On Error GoTo DiskError

Dir1.Path = Drive1.Drive

Exit Sub

DiskError:

MsgBox (“The disk is not ready.”), , _{—}

“Disk Not Ready”

Resume Stop Trying

Stop Trying:
End Sub

In an embodiment, the source code of Version 5.00 for the embodiment illustrated in FIGS. 13 or 14, for example, it is as follows:

Object =“{3B7C8863-D78F-101B-B9B5-04021C009402}#1.2#0”;

“RICHTX32.OCX”

Begin VB.Form Form2

| | |
|---|---|
| AutoRedraw | = −1 ‘True |
| BackColor | = &H00004000& |
| BorderStyle | = 0 ‘None |
| Caption | = “ANSI/ISO/ASQC Q9001-1994 4.1.1” |
| ClientHeight | = 7140 |
| ClientLeft | = 4245 |
| ClientTop | = 1920 |
| ClientWidth | = 8625 |
| LinkTopic | = “Form1” |
| MaxButton | = 0 ‘False |
| MinButton | = 0 ‘False |
| ScaleHeight | = 7140 |
| ScaleWidth | = 8625 |
| ShowInTaskbar | = 0 ‘False |
| StartUpPosition | = 2 ‘CenterScreen |

Begin VB.DriveListBox Drive1

| | |
|---|---|
| Height | = 315 |
| Left | = 120 |
| TabIndex | = 39 |
| Top | = 120 |
| Width | = 1575 |
| End | |

Begin RichTextLib.RichTextBox RichTextBox1

| | |
|---|---|
| Height | = 1095 |
| Left | = 1800 |
| TabIndex | = 35 |
| Top | = 2040 |
| Width | = 5415 |
| _ExtentX | = 9551 |
| _ExtentY | = 1931 |
| _Version | = 393217 |
| BackColor | = 65535 |
| Enabled | = −1 ‘True |
| TextRTF | = $“file_blder_1.frx”:0000 |
| End | |

Begin VB.CommandButton Command2

| | |
|---|---|
| BackColor | = &H00C000C0& |
| Caption | = “10” |
| Height | = 375 |
| Index | = 29 |
| Left | = 6840 |
| Style | = 1 ‘Graphical |
| TabIndex | = 34 |
| Top | = 6600 |
| Width | = 1695 |
| End | |

Begin VB.CommandButton Command2

| | |
|---|---|
| BackColor | = &H00C000C0& |
| Caption | = “9” |
| Height | = 375 |
| Index | = 28 |
| Left | = 5160 |
| Style | = 1 ‘Graphical |
| TabIndex | = 33 |
| Top | = 6600 |
| Width | = 1695 |
| End | |

Begin VB.CommandButton Command2

| | |
|---|---|
| BackColor | = &H00C000C0& |
| Caption | = “8” |
| Height | = 375 |
| Index | = 27 |
| Left | = 3480 |
| Style | = 1 ‘Graphical |
| Tabindex | = 32 |
| Top | = 6600 |
| Width | = 1695 |
| End | |

Begin VB.CommandButton Command2

| | |
|---|---|
| BackColor | = &H00C000C0& |
| Caption | = “7” |
| Height | = 375 |
| Index | = 26 |
| Left | = 1800 |
| Style | = 1 ‘Graphical |
| TabIndex | = 31 |
| Top | = 6600 |
| Width | = 1695 |
| End | |

Begin VB.CommandButton Command2

| | |
|---|---|
| BackColor | = &H00C000C0& |
| Caption | = “6” |
| Height | = 375 |
| Index | = 25 |
| Left | = 120 |
| Style | = 1 ‘Graphical |
| TabIndex | = 30 |
| Top | = 6600 |
| Width | = 1695 |
| End | |

Begin VB.CommandButton Command2

| | |
|---|---|
| BackColor | = &H00C000C0& |
| Caption | = “5” |
| Height | = 375 |
| Index | = 24 |
| Left | = 6840 |
| Style | = 1 ‘Graphical |
| TabIndex | = 29 |
| Top | = 6240 |
| Width | = 1695 |
| End | |

Begin VB.CommandButton Command2

| | |
|---|---|
| BackColor | = &H00C000C0& |
| Caption | = “4” |
| Height | = 375 |
| Index | = 23 |
| Left | = 5160 |
| Style | = 1 ‘Graphical |
| TabIndex | = 28 |
| Top | = 6240 |
| Width | = 1695 |
| End | |

Begin VB.CommandButton Command2

| | |
|---|---|
| BackColor | = &H00C000C0& |
| Caption | = “3” |
| Height | = 375 |
| Index | = 22 |
| Left | = 3480 |
| Style | = 1 ‘Graphical |
| TabIndex | = 27 |
| Top | = 6240 |
| Width | = 1695 |
| End | |

Begin VB.CommandButton Command2

| | |
|---|---|
| BackColor | = &H00C000C0& |
| Caption | = “2” |
| Height | = 375 |
| Index | = 21 |
| Left | = 1800 |
| Style | = 1 ‘Graphical |
| TabIndex | = 26 |
| Top | = 6240 |
| Width | = 1695 |
| End | |

Begin VB.CommandButton Command2

| | |
|---|---|
| BackColor | = &H00C000C0& |
| Caption | = “1” |
| Height | = 375 |
| Index | = 20 |
| Left | = 120 |
| Style | = 1 ‘Graphical |
| TabIndex | = 25 |
| Top | = 6240 |
| Width | = 1695 |
| End | |

Begin VB.CommandButton Command2

| | |
|---|---|
| BackColor | = &H00FFFF00& |
| Caption | = “10” |
| Height | = 375 |
| Index | = 19 |
| Left | = 6840 |
| Style | = 1 ‘Graphical |
| TabIndex | = 24 |
| Top | = 5640 |
| Width | = 1695 |
| End | |

Begin VB.CommandButton Command2

| | |
|---|---|
| BackColor | = &H00FFFF00& |
| Caption | = “9” |
| Height | = 375 |
| Index | = 18 |
| Left | = 5160 |
| Style | = 1 ‘Graphical |
| TabIndex | = 23 |
| Top | = 5640 |
| Width | = 1695 |
| End | |

Begin VB.CommandButton Command2

| | |
|---|---|
| BackColor | = &H00FFFF00& |
| Caption | = “8” |
| Height | = 375 |
| Index | = 17 |
| Left | = 3480 |
| Style | = 1 ‘Graphical |
| TabIndex | = 22 |
| Top | = 5640 |
| Width | = 1695 |
| End | |

Begin VB.CommandButton Command2

| | |
|---|---|
| BackColor | = &H00FFFF00& |
| Caption | = “7” |
| Height | = 375 |
| Index | = 16 |
| Left | = 1800 |
| Style | = 1 ‘Graphical |
| TabIndex | = 21 |
| Top | = 5640 |
| Width | = 1695 |
| End | |

Begin VB.CommandButton Command2

| | |
|---|---|
| BackColor | = &H00FFFF00& |
| Caption | = “6” |
| Height | = 375 |
| Index | = 15 |
| Left | = 120 |
| Style | = 1 ‘Graphical |
| TabIndex | = 20 |
| Top | = 5640 |
| Width | = 1695 |
| End | |

Begin VB.CommandButton Command2

| | |
|---|---|
| BackColor | = &H00FFFF80& |
| Caption | = “5” |
| Height | = 375 |
| Index | = 14 |
| Left | = 6840 |
| Style | = 1 ‘Graphical |
| TabIndex | = 19 |
| Top | = 5280 |
| Width | = 1695 |
| End | |

Begin VB.CommandButton Command2

| | |
|---|---|
| BackColor | = &H00FFFF00& |
| Caption | = “4” |
| Height | = 375 |
| Index | = 13 |
| Left | = 5160 |
| Style | = 1 ‘Graphical |
| TabIndex | = 18 |
| Top | = 5280 |
| Width | = 1695 |
| End | |

Begin VB.CommandButton Command2

| | |
|---|---|
| BackColor | = &H00FFFF00& |
| Caption | = “3” |
| Height | = 375 |
| Index | = 12 |
| Left | = 3480 |
| Style | = 1 ‘Graphical |
| TabIndex | = 17 |
| Top | = 5280 |
| Width | = 1695 |
| End | |

Begin VB.CommandButton Command2

| | |
|---|---|
| BackColor | = &H00FFFF00& |
| Caption | = “2” |
| Height | = 375 |
| Index | = 11 |
| Left | = 1800 |
| Style | = 1 ‘Graphical |
| TabIndex | = 16 |
| Top | = 5280 |
| Width | = 1695 |
| End | |

Begin VB.CommandButton Command2

| | |
|---|---|
| BackColor | = &H00FFFF00& |
| Caption | = “1” |
| Height | = 375 |
| Index | = 10 |
| Left | = 120 |
| Style | = 1 ‘Graphical |
| TabIndex | = 15 |
| Top | = 5280 |
| Width | = 1695 |
| End | |

Begin VB.CommandButton Command2

| | |
|---|---|
| BackColor | = &H000080FF& |
| Caption | = “10” |
| Height | = 375 |
| Index | = 9 |
| Left | = 6840 |
| Style | = 1 ‘Graphical |
| TabIndex | = 14 |
| Top | = 4680 |
| Width | = 1695 |
| End | |

Begin VB.CommandButton Command2

| | |
|---|---|
| BackColor | = &H000080FF& |
| Caption | = “9” |
| Height | = 375 |
| Index | = 8 |
| Left | = 5160 |
| Style | = 1 ‘Graphical |
| TabIndex | = 13 |
| Top | = 4680 |
| Width | = 1695 |
| End | |

Begin VB.CommandButton Command2

| | |
|---|---|
| BackColor | = &H000080FF& |
| Caption | = “8” |
| Height | = 375 |
| Index | = 7 |
| Left | = 3480 |
| Style | = 1 ‘Graphical |
| TabIndex | = 12 |
| Top | = 4680 |
| Width | = 1695 |
| End | |

Begin VB.CommandButton Command2

| | |
|---|---|
| BackColor | = &H000080FF& |
| Caption | = “7” |
| Height | = 375 |
| Index | = 6 |
| Left | = 1800 |
| Style | = 1 ‘Graphical |
| TabIndex | = 11 |
| Top | = 4680 |
| Width | = 1695 |
| End | |

Begin VB.CommandButton Command2

| | |
|---|---|
| BackColor | = &H000080FF& |
| Caption | = “6” |
| Height | = 375 |
| Index | = 5 |
| Left | = 120 |
| Style | = 1 ‘Graphical |
| TabIndex | = 10 |
| Top | = 4680 |
| Width | = 1695 |
| End | |

Begin VB.CommandButton Command2

| | |
|---|---|
| BackColor | = &H000080FF& |
| Caption | = “5” |
| Height | = 375 |
| Index | = 4 |
| Left | = 6840 |
| Style | = 1 ‘Graphical |
| TabIndex | = 9 |
| Top | = 4320 |
| Width | = 1695 |
| End | |

Begin VB.Command Button Command2

| | |
|---|---|
| BackColor | = &H000080FF& |
| Caption | = “4” |
| Height | = 375 |
| Index | = 3 |
| Left | = 5160 |
| Style | = 1 ‘Graphical |
| TabIndex | = 8 |
| Top | = 4320 |
| Width | = 1695 |
| End | |

Begin VB.CommandButton Command2

| | |
|---|---|
| BackColor | = &H000080FF& |
| Caption | = “3” |
| Height | = 375 |
| Index | = 2 |
| Left | = 3480 |
| Style | = 1 ‘Graphical |
| TabIndex | = 7 |
| Top | = 4320 |
| Width | = 1695 |
| End | |

Begin VB.CommandButton Command2

| | |
|---|---|
| BackColor | = &H000080FF& |
| Caption | = “2” |
| Height | = 375 |
| Index | = 1 |
| Left | = 1800 |
| Style | = 1 ‘Graphical |
| TabIndex | = 6 |
| Top | = 4320 |
| Width | = 1695 |
| End | |

Begin VB.ComboBox Combo1

| | |
|---|---|
| BackColor | = &H00C0C0C0& |
| Height | = 315 |
| ItemData | = “file_blder_1.frx”:00E1 |
| Left | = 120 |
| List | = “file_blder_1.frx”:0196 |
| TabIndex | = 4 |
| Text | = “Click on the right to nevigate” |
| Top | = 3600 |
| Width | = 8415 |
| End | |

Begin VB.CommandButton Command2

| | |
|---|---|
| BackColor | = &H000080FF& |
| Caption | = “1” |
| Height | = 375 |
| Index | = 0 |
| Left | = 120 |
| Style | = 1 ‘Graphical |
| TabIndex | = 3 |
| Top | = 4320 |
| Width | = 1695 |
| End | |

Begin VB.TextBox Text1

| | |
|---|---|
| BackColor | = &H00C0C0C0& |
| Height | = 1815 |
| Left | = 1800 |
| MultiLine | = −1 ‘True |
| ScrollBars | = 2 ‘Vertical |
| TabIndex | = 2 |
| Text | = “file_blder_1.frx”:09C3 |
| Top | = 120 |
| Width | = 6735 |
| End | |

Begin VB.FileListBox File1

| | |
|---|---|
| BackColor | = &H0000FF00& |
| Height | = 1845 |
| Left | = 120 |
| Normal | = 0 ‘False |
| TabIndex | = 1 |
| Top | = 1320 |
| Width | = 1575 |
| End | |

Begin VB.DirListBox Dir1

| | |
|---|---|
| BackColor | = &H00FF8080& |
| Height | = 765 |
| Left | = 120 |
| TabIndex | = 0 |
| Top | = 480 |
| Width | = 1575 |
| End | |

Begin VB.Image Image1

| | |
|---|---|
| BorderStyle | = 1 ‘Fixed Single |
| Height | = 1095 |
| Left | = 7320 |
| MouseIcon | = “file_blder_1.frx”:0A6A |
| MousePointer | = 4 ‘Icon |
| Picture | = “file_blder_1.frx”:0BBC |
| Stretch | = −1 ‘True |
| ToolTipText | = “Click to Continue” |
| Top | = 2040 |
| Width | = 1185 |
| End | |

Begin VB.Label Label4

| | |
|---|---|
| AutoSize | = −1 ‘True |
| BackColor | = &H00FFFF00& |
| BackStyle | = 0 ‘Transparent |
| Caption | = “Save as Record Numbered or Named as bellow:” |

BeginProperty Font

| | |
|---|---|
| Name | = “MS Sans Serif” |
| Size | = 8.25 |
| Charset | = 0 |
| Weight | = 700 |
| Underline | = 0 ‘False |
| Italic | = 0 ‘False |
| Strikethrough | = 0 ‘False |

End Property

| | |
|---|---|
| ForeColor | = &H00FFFF00& |
| Height | = 195 |
| Left | = 2280 |
| TabIndex | = 38 |
| Top | = 5040 |
| Width | = 4080 |
| End | |

Begin VB.Label Label3

| | |
|---|---|
| AutoSize | = −1 ‘True |
| BackColor | = &H00C000C0& |
| BackStyle | = 0 ‘Transparent |
| Caption | = “Save as Procedure Numbered or Named as |
| | bellow:” |

BeginProperty Font

| | |
|---|---|
| Name | = “MS Sans Serif” |
| Size | = 8.25 |
| Charset | = 0 |
| Weight | = 700 |
| Underline | = 0 ‘False |
| Italic | = 0 ‘False |
| Strikethrough | = 0 ‘False |

End Property

| | |
|---|---|
| ForeColor | = &H00FF00FF& |
| Height | = 195 |
| Left | = 2160 |
| TabIndex | = 37 |
| Top | = 6000 |
| Width | = 4335 |
| End | |

Begin VB.Label Label2

| | |
|---|---|
| AutoSize | = −1 ‘True |
| BackColor | = &H000080FF& |
| BackStyle | = 0 ‘Transparent |
| Caption | = “Save as Policy Numbered or Named as bellow:” |

BeginProperty Font

| | |
|---|---|
| Name | = “MS Sans Serif” |
| Size | = 8.25 |
| Charset | = 0 |
| Weight | = 700 |
| Underline | = 0 ‘False |
| Italic | = 0 ‘False |
| Strikethrough | = 0 ‘False |

End Property

| | |
|---|---|
| ForeColor | = &H000080FF& |
| Height | = 195 |
| Index | = 0 |
| Left | = 2400 |
| TabIndex | = 36 |
| Top | = 4080 |
| Width | = 3975 |
| End | |

Begin VB.Label Label1

| | |
|---|---|
| Alignment | = 2 ‘Center |
| BackStyle | = 0 ‘Transparent |
| Caption | = “Please use the light grey window bellow to |
| | nevigate” |

BeginProperty Font

| | |
|---|---|
| Name | = “MS Sans Serif” |
| Size | = 12 |
| Charset | = 0 |
| Weight | = 400 |
| Underline | = 0 ‘False |
| Italic | = 0 ‘False |
| Strikethrough | = 0 ‘False |

End Property

| | |
|---|---|
| ForeColor | = &H0000FFFF& |
| Height | = 255 |
| Left | = 120 |
| TabIndex | = 5 |
| Top | = 3240 |
| Width | = 8415 |

End
End
Attribute VB_Name = “Form2”
Attribute VB_GlobalNameSpace = False
Attribute VB_Creatable = False
Attribute VB_PredeclaredId = True
Attribute VB_Exposed = False
Private Sub Combo1_Click()
Dim Sub_Cat_Name$(30)
M = 1
Do Until M = 31
On Error Resume Next
Close #M
M = M + 1
Loop

Text2=“Please read the information bellow regarding the current” &_{—}

“directory your are building, and then to find the file” &_{—}

“to fill in a file category, please” & Chr(13)+Chr(10) &_{—}

“ “ & Chr(13 )+Chr(10) &_{—}

“1. Use the red window to choose a drive” & Chr(13)+Chr(10) &_{—}

“2. Use the blue window to choose a directory” & Chr(13)+Chr(10) &_{—}

“3. Use the green window to choose a file” & Chr(13)+Chr(10) &_{—}

“4. Use the light grey window to choose a category and the dark grey window to vieew the existing files in the chosen category” & Chr(13)+Chr(10) &_{—}

“5. Use the yellow window to type in a user-defined file name of maximum 8 letters. Press Enter to continue typing, if you wish to add additional comments which may be viewed with the Quality Control Demonstrator” & Chr(13)+Chr(10) &_{—}

“6. Use the numbered ‘Save as Procedure’, ‘Save as Form’, or ‘Save as Document’ button to save the file into the chosen categoryh of the file structure” & Chr(13)+Chr(10) &_{—}

“ “ & Chr(13)+Chr(10) &_{—}

“Information regarding the current directory:” & Chr(13)+Chr(10) &_{—}

“” & Chr(13)+Chr(10)

Select Case Combo1.Text

Case “4.1.1 Quality Policy”

Text1.Text=₁₃

“The supplier's management with executive responsibility 4WI” &₁₃

“define and document its policy for quality, including” &_{—}

“objectives for quality and its commitment to quality.” &_{—}

“The quality policy 4WI be relevant to the supplier's” &_{—}

“organizational goals and the expectations and needs of its” &_{—}

“customers. The supplier shall ensure that this policy is” &_{—}

“understood, implemented, and maintained at all levels of” &_{—}

“the organization.”

Case “4.1.2.1 Organizational Responsibility and Authority”

Text1.Text=“The responsibility, authority, and the interrelation of personnel who manage, perform, and verify work affecting quality shall be defined and documented, particularly for personnel who need the organizational freedom and authority to:” & Chr(13)+Chr(10) &_{—}

“ ” & Chr(13)+Chr(10) &_{—}

“a) initiate action to prevent the occurrence of any nonconfirmities relating to product, process, and quality system;” & Chr(13)+Chr(10) &_{—}

“ ” & Chr(13)+Chr(10) &_{—}

“b) identify and record any problems relating to the product, process, and quality system;” & Chr(13)+Chr(10) &_{—}

“ ” & Chr(13)+Chr(10) &_{—}

“c) initiate, recommend, or provide solutions through designated channels;” & Chr(13)+Chr(10) &_{—}

“ ” Chr(13)+Chr(10) &_{—}

“d) verify the implementation of solutions;” & Chr(13)+Chr(10) &_{—}

“ ” & Chr(13)+Chr(10) &_{—}

e) control further processing, delivery, or installation of nonconforming product until the deficiency or unsatisfactory condition has been corrected.”

Case “4.1.2.2 Organizational Resources”

Text1.Text=“The supplier shall identify resource requirements and provide adequate resources, including the assignment of trained personnel (see 4.18), for management, performance of work, and verification activities including internal qualitiy audits.”

Case “4.1.2.3 Management Representative”

Text1.Text=“The supplier's management with executive responsibility shall appoint a memberof the supplier's own management who, irrespective of other responsibilities, shall have defined authority for” & Chr(13)+Chr(10) &_{—}

“ ” & Chr(13)+Chr(10) &_{—}

“a) ensuring that a quality system is established, implemented, and maintained in accordance with this American National Standard, and” & Chr(13)+Chr(10) &_{—}

“ ” & Chr(13)+Chr(10) &_{—}

“b) reporting on the performance of the quality system to the supplier's management for review and as a basis for improvement of the quality system.” & Chr(13)+Chr(10) &_{—}

“ ” & Chr(13)+Chr(10) &_{—}

“NOTE 5 The responsibility of a management representative may also include liaison with external parties on matters relating to the supplier's quality system.”

Case “4.1.3 Management Review”

Text1.Text=“The supplier's management with executive responsibility shall review the quality system at defined intervals sufficient to ensure its continuing suitability and effectiveness in satisfying the requirements of this American National Standard and the supplier's stated quality policy and objectives (see 4.1.1). Records of such reviews shall be maintained (see 4.16).”

Case “4.2.1 General Quality Systems”

Text1.Text=“The supplier shall establish, document, and maintain a quality system as a means of ensuring that product conforms to specified requirements. The supplier shall prepare a quality manual covering the requirements of this American National Standard. The quality manual shall include or make reference to the quality-system procedures and outline the structure of the documentation used in the quality system.” & Chr(13)+Chr(10) &_{—}

“ ” & Chr(13)+Chr(10) &_{—}

NOTE 6: Guidance on quality manuals is given in ISO 10013.”

Case “4.2.2 Quality-system Procedures”

Text1.Text=“The supplier shall” & Chr(13)+Chr(10) &_{—}

“ ”& Chr(13)+Chr(10) &_{—}

“a) prepare documented procedures consistent with the” & Chr(13)+Chr(10) &_{—}

“ ” Chr(13)+Chr(10) &_{—}

“requirements of this American National Standard and the supplier's stated quality policy, and” & Chr(13)+Chr(10) &_{—}

“b) effectively implement the quality system and its documented procedures.” & Chr(13)+Chr(10) &_{—}

“For the purposes of this American National Standard, the range and detail of the procedures that form part of the quality system shall be dependent upon the complexity of the work, the methods used, and the skills and training needed by personnel involved in carrying out the activity.” & Chr(13)+Chr(10) &_{—}

“ ” & Chr(13)+Chr(10) &_{—}

“NOTE 7 Documented procedures may make reference to work instructions that define how an activity is performed.”

Case “4.2.3 Quality Planning”

Text1.Text=“The supplier shall define and document how the requirements for quality will be met. Quality planning shall be consistent with all other requirements of a supplier's quality system and shall be documented in a format to suit the supplier'method of operation. The supplier shall give consideratrion to the following activities, as appropriate, in meeting the specified requirements for preducts, projects, or contracts:” & Chr(13)+Chr(10) &_{—}

“a) the preparation of quality plans;” & Chr(13)+Chr(10) &_{—}

“b) the identification and acquisition of any controls,” &_{—}

“processes, equipment (including inspection and test equipment), fixtures, resources, and skills that may be needed to achieve the required quality;” & Chr(13)+Chr(10) &_{—}

“c) ensuring the compatibility of the design, the production process, installation, servicing, inspection and test procedures, and the applicable documentation;” & Chr(13)+Chr(10) &_{—}

“d) the updating, as necessary, of quality control, inspection, and testing techniques, including the development of new instrumentation;” Chr(13)+Chr(10) &_{—}

“e) the identification of any measurement requirement involving capability that exceeds the known state of the art, in sufficient time for the needed capability to be developed;” & Chr(13)+Chr(10) &_{—}

“f) the identification of suitable verification at appropriate stages in the realization of product;” & Chr(13)+Chr(10) &_{—}

“g) the clarification of standards of acceptability for all features and requirements, including those which contain a subjective element;” & Chr(13)+Chr(10) &_{—}

“h) the identification and preparation of quality records (see 4.16).” & Chr(13)+Chr(10) &_{—}

“NOTE 8 The quality plans referred to (see 4.2.3a) may” Chr(13)+Chr(10) &_{—}

“be in the form of a reference to the appropriate documented procedures that form an integral part of the supplier's quality system.”

Case “4.3.1 General Contract Review”

Text1.Text=“The supplier shall establish and maintain documented procedures for contract review and for the coordination of these activities.”

Case “4.3.2 Review of Contract”

Text1.Text=“Before submission of a tender, or at the acceptance of a contract or order (statement of requirement), the tender, contract, or order shall be reviewed by the suplier to ensure that:” & Chr(13)+Chr(10) &_{—}

“ ” & Chr(13)+Chr(10) &_{—}

a) the requirements are adequately defined and documented; where no written statement of requirement is available for an order received by verbal means, the supplier shall ensure that the order requirements are agreed before their acceptance;” & Chr(13)+Chr(10) &_{—}

“ ” & Chr(13)+Chr(10) &_{—}

“b) any differences between the contract or accepted order requirements and those in the tender are resolved;” Chr(13)+Chr(10) &_{—}

“ ” & Chr(13)+Chr(10) &_{—}

“c) the supplier has the capability to meet the contract or” & Chr(13)+Chr(10) &_{—}

“accepted order requirements.”

Case “4.3.3 Amendment to Contract”

Text1.Text=“The supplier shall identify how an amendment to a contract is made and correctly transferred to the functions concerned within the supplier's organization.”

Case “4.3.4 Records of Contract”

Text1.Text=“Records of contract reviews shall be maintained (see 4.16).” & Chr(13)+Chr(10) &_{—}

“NOTE 9: Channels for communication and interfaces with the customer's organization in these contract matters should be established.”

Case “4.4.1 General Design Control”

Text1.Text=“The supplier shall establish and maintain documented procedures to control arid verify the design of the product in order to ensure that the specified requirements are met.”

Case “4.4.2 Design and Development Planning”

Text1.Text=“The supplier shall prepare plans for each design and development activity. The plans shall describe or reference these activities, and define responsibility for their implementation. The design and development activities shall be assigned to qualified personnel equipped with adequate resources. The plans shall be updated, as the design evolves.”

Case “4.4.3 Organizational and Technical Interfaces”

Text1.Text=“Organizational and technical interfaces between different groups which input into the design process shall be defined and the necessary information documented, transmitted, and regularly reviewed.”

Case “4.4.4 Design Input”

Text1.Text=“Design-input requirements relating to the product, including applicable statutory and regulatory requirements, shall be identified, documented, and their selection reviewed by the supplier for adequacy. Incomplete, ambiguous, or conflicting requirements shall be resolved with those responsible for imposing these requirements.”

Case “4.4.5 Design Output”

Text1.Text=“Design output shall be documented and expressed in terms that can be verified against design-input requirements and validated (see 4.4.8).” & Chr(13)+Chr(10) &_{—}

“Design output shall;” & Chr(13)+Chr(10) &_{—}

“ ” & Chr(13)+Chr(10) &_{—}

“a) meet the design-input requirements;” & Chr(13)+Chr(10) &_{—}

“ ” & Chr(13)+Chr(10) &_{—}

“b) contain or make reference to acceptance criteria;” & Chr(13)+Chr(10) &_{—}

“ ” & Chr(13)+Chr(10) &_{—}

“c) identify those characteristics of the design that are crucial to the safe and proper functioning of the product (e.g., operating, storage, handling, maintenance, and disposal requirements).” & Chr(13)+Chr(10) &_{—}

“ ”& Chr(13)+Chr(10) &_{—}

“Design-output documents shall be reviewed before release.”

Case “4.4.6 Design Review”

Text1.Text=“At appropriate stages of design, formal documented reviews of the design results shall be planned and conducted. Participants at each design review shall include representatives of all functions concerned with the design stage being reviewed, as well as other specialist personnel, as required. Records of such reviews shall be maintained (see 4.16).”

Case “4.4.7 Design Verification”

Text1.Text=“At appropriate stages of design, design verification shall be performed to ensure that the design-stage output meets the design-stage input requirements. The design-verification measures shall be recorded (see 4.16).” & Chr(13)+Chr(10) &_{—}

“ ” & Chr(13)+Chr(10) &_{—}

“NOTE 10: In addition to conducting design reviews (see 4.4.6), design verification may include activities such as” & Chr(13)+Chr(10) &_{—}

“ ” & Chr(13)+Chr(10) &_{—}

“a) performing alternative calculations,” & Chr(13)+Chr(10) &_{—}

“ ” & Chr(13)+Chr(10) &_{—}

“b) comparing the new design with a similar proven design, if available,” & Chr(13)+Chr(10) &_{—}

“ ” & Chr(13)+Chr(10) &_{—}

“c) undertaking tests and demonstrations,” & Chr(13)+Chr(10) &_{—}

“ ” & Chr(13)+Chr(10) &_{—}

“d) and -reviewing the design-stage documents before release.”

Case “4.4.8 Design Validation”

Text1.Text=“Design validation shall be performed to ensure that product conforms to defined user needs and/or requirements.” & Chr(13)+Chr(10) &_{—}

“NOTES” & Chr(13)+Chr(10) &_{—}

“11: Design validation follows successful design verification (see 4.4.7).” & Chr(13)+Chr(10) &_{—}

“12: Validation is mormally performed under defined operating conditions.” & Chr(13)+Chr(10) &_{—}

“13: Validation is normally performed on the final product, but may be necessary in earlier stages prior to product completion.” & Chr(13)+Chr(10) &_{—}

“14: Multiple validations may be performed if there are different intended used.”

Case “4.4.9 Design Changes”

Text1.Text=“All design changes and modifications shall be identified, documented, reviewed, and approved by authorized personnel before their implementation.”

Case “4.5.1 General Document and Data Control”

Text1.Text=“The supplier shall establish and maintain documented procedures to control all documents and data that relate to the requirements of this American National Standard including, to the extent applicable, documents of external origin such as standards and customer drawings.” & Chr(13)+Chr(10) &_{—}

“NOTE 15: Documents and data can be in the form of any type of media, such as hard copy or electronic media.”

Case “4.5.2 Document and Data Approval and Issue”

Text1.Text=“The documents and data shall be reviewed and approved for adequacy by authorized personnel prior to issue. A master list or equivalent document-control procedure identifying the current revision status of documents shall be established and be readily available to preclude the use” &_{—}

“of invalid and/or obsolete documents.” & Chr(13)+Chr(10) &_{—}

“ ” & Chr(13)+Chr(10) &_{—}

“This control shall ensure that:” & Chr(13)+Chr(10) &_{—}

“” & Chr(13)+Chr(10) &_{—}

“a) the pertinent issues of appropriate documents are available at all locations where operations essential to the effective functioning of the quality system are performed;” & Chr(13)+Chr(10) &_{—}

“” & Chr(13)+Chr(10) &_{—}

“b) invalid and/or obsolete documents are promptly removed from all points of issue or use, or otherwise assured against unintended use;” & Chr(13)+Chr(10) &_{—}

“ ” & Chr(13)+Chr(10) &_{—}

“c) any obsolete documents retained for legal and/or knowledge-preservation purposes are suitably identified.”

Case “4.5.3 Document and Data Changes”

Text1.Text=“Changes to documents and data shall be reviewed and approved by the same functions/organizations that performed the original review and approval, unless specifically designated otherwise. The designated functions/organizations shall have access to pertinent background information upon which to base their review and approval.” & Chr(13)+Chr(10) &_{—}

“ ” & Chr(13)+Chr(10) &_{—}

“Where practicable, the nature of the change shall be identified in the document or the appropriate attachments.”

Case “4.6.1 General Purchasing”

Text1.Text=“The supplier shall establish and maintain documented procedures to ensure that purchased product (see 3.1) conforms to specified requirements.”

Case “4.6.2 Evaluation of Subcontractors”

Text1.Text=“The supplier shall:” & Chr(13)+Chr(10) &_{—}

“ ” & Chr(13)+Chr(10) &_{—}

“a) evaluate and select subcontractors on the basis of their ability to meet subcontract requirements including the quality system and any specific quality-assurance requirements;” & Chr(13)+Chr(10) &_{—}

“ ” & Chr(13)+Chr(10) &_{—}

“b) define the type and extent of control exercised by the supplier over subcontractors. This shall be dependent upon the type of product, the impact of subcontracted product on the quality of final product, and, where applicable, on the quality audit reports and/or quality records of the previously demonstrated capability and performance of subcontractors;” & Chr(13)+Chr(10) &_{—}

“ ” & Chr(13)+Chr(10) &_{—}

“c) establish and maintain quality records of acceptable subcontractors (see 4.16).”

Case “4.6.3 Purchasing Data”

Text1.Text=“Purchasing documents shall contain data clearly describing the product ordered, including where applicable:” & Chr(13)+Chr(10) &_{—}

“ ” & Chr(13)+Chr(10) &_{—}

“a) the type, class, grade, or other precise identification;” & Chr(13)+Chr(10) &_{—}

“ ” & Chr(13)+Chr(10) &_{—}

“b) the title or other positive identification, and applicable issues of specifications, drawings, process requirements, inspection instructions, and other relevant technical data, including requirements for approval or qualification of product, procedures, process equipment, and personnel;” & Chr(13)+Chr(10) &_{—}

“ ” & Chr(13)+Chr(10) &_{—}

“c) the title, number, and issue of the quality-system standard to be applied.” & Chr(13)+Chr(10) &_{—}

“ ” & Chr(13)+Chr(10) &_{—}

“The supplier shall review and approve purchasing documents for adequacy of the specified requirements prior to release.”

Case “4.6.4.1 Supplier Verification at Subcontractor's Premises”

Text1.Text=“Where the supplier proposes to verify purchased product at the subcontractor's premises, the supplier shall specify verification arrangements and the method of product release in the purchasing documents.”

Case “4.6.4.2 Customer Verification of Subcontracted Product”

Text1.Text=“Where specified in the contract, the supplier's customer or the customer's representative shall be afforded the right to verify at the subcontractor's premises and the supplier's premises that subcontracted product conforms to specified requirements. Such verification shall not be used by the supplier as evidence of effective control of quality by the subcontractor.” & Chr(13)+Chr(10) &_{—}

“Verification by the customer shall not absolve the supplier of the responsibility to provide acceptable product, nor shall it preclude subsequent rejection by the customer.”

Case “4.7 Control of Customer-Supplied Product”

Text1.Text=“The supplier shall establish and maintain documented procedures for the control of verification, storage, and maintenance of customer-supplied product provided for incorporation into the supplies or for related activities. Any such product that is lost, damaged, or is otherwise unsuitable for use shall be recorded and reported ot the customer (see 4.16).” & Chr(13)+Chr(10) &_{—}

“ ” & Chr(13)+Chr(10) &_{—}

“Verification by the supplier does not absolve the customer of the responsibility to provide acceptable product.”

Case “4.8 Product Indentification and Traceability”

Text1.Text=“Where appropriate, the supplier shall establish and maintain documented procedures for identifying the product by suitable means from receipt and during all stages of production, delivery, and installation.” & Chr(13)+Chr(10) &_{—}

“ ” & Chr(13)+Chr(10) &_{—}

“Where and to the extent that traceability is a specified requirement, the supplier shall establish and maintain documented procedures for unique identification of individual product or batches. This identification shall be recorded (see 4.16).”

Case “4.9 Process Control”

Text1.Text= “The supplier shall identify and plan the production, installation, and servicing processes which directly affect quality and shall ensure that these processes are carried out under controlled conditions. Controlled conditions shall include the following:” & Chr(13) +Chr(10) & _

“a) documented procedures defining the manner of production, installation, and servicing, where the absence of such procedures could adversely affect quality;” & Chr(13) +Chr(10) & _

“b) use of suitable production, installation, and servicing equipment, and a suitable working environment;” & Chr(13)+Chr(10) & _

“c) compliance with reference standards/codes, quality plans, and/or documented procedures;” & Chr(13)+Chr(10) & _

“d) monitoring and control of suitable process parameters and product characteristics;” & Chr(13)+Chr(10) & _

“e) the approval of processes and equipment, as appropriate;” & Chr(1 3) +Chr(10) & _

“f) criteria for workmanship, which shall be stipulated in the clearest practical manner (e.g., written standards, representative samples, or illustrations);” & Chr(13)+Chr(10) & _

“g) suitable maintenance of equipment to ensure continuing process capability.” & Chr(13) +Chr(10) & _“Where the results of processes cannot be fully verified by subsequent inspection and testing of the product and where, for example, processing deficiencies may become apparent only after the product is in use, the processes shall be carried out by qualified operators and/or shall require continuous monitoring and control of process parameters to ensure that the specified requirements are met.” & Chr(13)+Chr(10) & _“The requirements for any qualification of process operations, including associated equipment and personnel (see 4.18), shall be specified.” & Chr(13) +Chr(10) & _“NOTE 16 Such processes requiring pre qualification of their process capability are frequently referred to as special processes.” & Chr(13)+Chr(10) & _“Records shall be maintained for qualified processes, equipment, and personnel, as appropriate (see 4.16).”

Case “4.10.1 General Inspection and Testing”

Text1.Text= “The supplier shall establish and maintain documented procedures for inspection and testing activities in order to verify that the specified requirements for the product are met. 71 be required inspection and testing, and the records to be established, shall be detailed in the quality plan or documented procedures”

Case “4.10.2.1 Receiving Inspection and Testing—(Prior to Process)”

Text1.Text= “The supplier shall ensure that incoming product is not used or processed (except in the circumstances described in 4.10.2.3) until it has been inspected or otherwise verified as conforming to specified requirements.

Verification of the specified requirements shall be in accordance with the quality plan and/or documented procedures”

Case “4.10.2.2 Receiving Inspection and Testing—(Recorded Evidence)”

Text1.Text= “In determining the amount and nature of receiving inspection, consideration shall be given to the amount of control exercised at the subcontractor's premises and the recorded evidence of conformance provided.”

Case “4.10.2.3 Receiving Inspection and Testing—(Immediate Recall)”

Text1.Text= “Where incoming product is released for urgent production purposes prior to verification, it shall be positively identified and recorded (see 4.16) in order to permit immediate recall and replacement in the event of nonconformity to specified requirements.”

Case “4.10.3 In-process Inspection and Testing”

Text1.Text= “The supplier shall:” & Chr(13)+Chr(10) & _““Chr(13)+Chr(10) & _

“a) inspect and test the product as required by the quality plan and/or documented procedures;” & Chr(13)+Chr(10) & _““Chr(13)+Chr(10) & _

“b) hold product until the required inspection and tests have been completed or necessary reports have been received and verified, except when product is released under positive-recall procedures (see 4.10.2.3). Release under positive-recall procedures shall not preclude the activities outlined in 4.10.3a”

Case “4.10.4 Final Inspection and Testing“

Text1.Text= “The supplier shall carry out all final inspection and testing in accordance with the quality plan and/or documented procedures to complete the evidence of conformance of the finished product to the specified requirements.” & Chr(13)+Chr(10) & _“The quality plan and/or documented procedures for final inspection and testing shall require that all specified inspection and tests, including those specified either on receipt of product or in-process, have been carried out and that the results meet specified requirements.” & Chr(1 3) +Chr(1 0) & _“No product shall be dispatched until all the activities specified in the quality plan and/or documented procedures have been satisfactorily completed and the associated data and documentation are available and authorized”

Case “4.10.5 Inspection and Test Records”

Text1.Text= “The supplier shall establish and maintain records which provide evidence that the product has been inspected and/or tested. These records shall show clearly whether the product has passed or failed the inspections and/or tests according to defined acceptance criteria. Where the product fails, to pass any inspection and/or test, the procedures for control of nonconforming product shall apply (see 4.13).” & Chr(13)+Chr(10) & _““& Chr(13)+Chr(10) & _“Records shall identify the inspection authority responsible for the release of product (see 4.16)”

Case “4.11.1 General Control of Inspection, Measuring, and Test Equipment”

Text1.Text= “The supplier shall establish and maintain documented procedures to control, calibrate, and maintain inspection, measuring, and test equipment (including test software) used by the supplier to demonstrate the conformance of product to the specified requirements. Inspection, measuring, and test equipment shall be used in a manner which ensures that the measurement uncertainty is known and is consistent with the required measurement capability” & Chr(13)+Chr(10) & _““& Chr(13)+Chr(10) & _“Where test software or comparative references such as test hardware are used as suitable forms of inspection, they shall be checked to prove that they are capable of verifying the acceptability of product, prior to release for use during production, installation, or servicing, and shall be rechecked at prescribed intervals. The supplier shall establish the extent and frequency of such checks and shall maintain records as evidence of control (see 4.16).” & Chr(13)+Chr(10) & _““& Chr(13)+Chr(10) & _“Where the availability of technical data pertaining to the measurement equipment is a specified requirement, such data shall be made available, when required by the customer or customer's representative, for verification that the measuring equipment is functionally adequate.” & Chr(13)+Chr(10) ““&Chr(13)+Chr(10) & _

“NOTE 17: For the purposes of this American National Standard, the term 'measuring equipment'includes measurement devices”

Case “4.11.2 Control Procedure”

Text1.Text= “The supplier shall:” & Chr(13)+Chr(10) & _determine the measurements to be made an@ the accuracy required, and select the appropriate inspection, measuring, and test equipment that is capable of the necessary accuracy and precision;” & Chr(13)+Chr(10) & _

“b) identify all inspection, measuring, and test equipment that can affect product quality, and calibrate and adjust them at prescribed intervals, or prior to use, against certified equipment having a known valid relationship to internationally or nationally recognized standards. Where no such standards exist, the basis used for calibration shall be documented;” & Chr(13)+Chr(10) & _

“c) define the process employed for the calibration of inspection, measuring, and test equipment, including details of equipment type, unique identification, location, frequency of checks, check method, acceptance criteria, and the action to be taken when results are unsatisfactory;” & Chr(13)+Chr(10) & _

“d) identify inspection, measuring, and test equipment with a suitable indicator or approved identification record to show the calibration status;” & Chr(1 3) +Chr(10) & _

“e) maintain calibration records for inspection, measuring, and test equipment (see 4.16);” & Chr(13)+Chr(10) & _

“f) assess and document the validity of previous inspection and test results when inspection, measuring, and test equipment is found to be out of calibration;” & Chr(13)+Chr(10) & _

“g) ensure that the environmental conditions are suitable for the calibrations, inspections, measurements, and tests being carried out;” & Chr(13)+Chr(10) & _

“h) ensure that the handling, preservation, and storage of inspection, measuring, and test equipment is such that the accuracy and fitness for use are maintained;” & Chr(13)+Chr(10) & _

“i) safeguard inspection, measuring, and test facilities, including both test hardware and test software, from adjustments which would invalidate the calibration setting.” & Chr(13)+Chr(10) & _

NOTE 18 The metrological confirmation system for measuring equipment given in ISO 10012 may be used for guidance”

Case “4.12 Inspection and Test Status”

Text1.Text= “The inspection and test status of product shall be identified by suitable means, which indicate the confarmance or nonconformance of product with regard to inspection and tests performed. lHe identification of inspection and test status shall be maintained, as defined in the quality plan and/or documented procedures, throughout production, installation, and servicing of the product to ensure that only product that has passed the required inspections and tests [or released under an authorized concession (see 4.13.2)] is dispatched, used, or installed”

Case “4.13.1 General Control of Nonconforming Product”

Text1.Text= “The supplier shall establish and maintain documented procedures to ensure that product that does not conform to specified requirements is prevented from unintended use or installation. This control shall provide for identification, documentation, evaluation, segregation (when practical), disposition of nonconforming product, and for notification to the functions concerned”

Case “4.13.2 Review and Disposition of Nonconforming Product”

Text1.Text= “The responsibility for review and authority for the disposition of nonconforming product shall be defined.” & Chr(13)+Chr(10) & _“Nonconforming product shall be reviewed in accordance with documented procedures. It may be” & Chr(13)+Chr(10) & _““& Chr(13)+Chr(10) & _

“a) reworked to meet the specified requirements,” & Chr(13)+Chr(10) & _

“b) accepted with or without repair by concession,” & Chr(13)+Chr(10) & _

“c) regarded for alternative applications, or” & Chr(13)+Chr(10) & _

“d) rejected or scrapped.” & Chr(13)+Chr(10) & _“Where required by the contract, the proposed use or repair of product (see 4.13.2b) which does not conform to specified requirements shall be reported for concession to the customer or customer's representative. The description of the nonconformity that has been accepted, and of repairs, shall be recorded to denote the actual condition (see 4.16).” & Chr(13)+Chr(10) & _“Repaired and/or reworked product shall be reinspected in accordance with the quality plan and/or documented procedures”

Case “4.14.1 General Corrective and Preventive Action”

Text1.Text= “The supplier shall establish and maintain documented procedures for implementing corrective and preventive action.” & Chr(13)+Chr(10) & _““& Chr(13)+Chr(1 0) & _“Any corrective or preventive action taken to eliminate the causes of actual or potential nonconformities shall be to a degree appropriate to the magnitude of problems and commensurate with the risks encountered.” & Chr(13)+Chr(10) & _““& Chr(13)+Chr(10) & _“The supplier shall implement and record any changes to the documented procedures resulting from corrective and preventive action”

Case “4.14.2 Corrective Action”

Text1.Text= “The procedures for corrective action shall include:” & Chr(13)+Chr(10) & _

“a) the effective handling of customer complaints and reports of product non conformities;” & Chr(13)+Chr(10) & _

“b) investigation of the cause of non conformities relating to product, process, and quality system, and recording the results of the investigation (see 4.16);” & Chr(13)+Chr(10) & _

“c) determination of the corrective action needed to eliminate the cause of non conformities;” & Chr(13)+Chr(10) & _

“d) application of controls to ensure that corrective action is taken and that it is effective”

Case “4.14.3 Preventive Action”

Text1.Text= “The procedures for preventive action shall include:” & Chr(13)+Chr(10) & _““& Chr(13)+Chr(10) & _

“a) the use of appropriate sources of information such as processes and work operations which affect product quality, concessions, audit results, quality records, service reports, and customer complaints to detect, analyze, and eliminate potential causes of nonconformities;” & Chr(13)+Chr(10) & _““& Chr(13)+Chr(10) & _

“b) determination of the steps needed to deal with any problems requiring preventive action;” & Chr(13)+Chr(10) & _““& Chr(13)+Chr(10) & _

“c) initiation of preventive action and application of controls to ensure that it is effective;” & Chr(13)+Chr(10) & _““&Chr(13)+Chr(10) & _

“d) ensuring that relevant information on actions taken is submitted for management review (see 4.1.3)”

Case “4.15.1 General Handling, Storage, Packaging, Preservation, and Delivery”

Text1.Text= “The supplier shall establish and maintain documented procedures for handling, storage, packaging, preservation, and delivery of product”

Case “4.15.2 Handling”

Text1.Text= “The supplier shall provide methods of handling product that prevent damage or deterioration”

Case “4.15.3 Storage”

Text1.Text= “The supplier shall use designated storage areas or stock rooms to prevent damage or deterioration of product, pending use or delivery. Appropriate methods for authorizing receipt to and dispatch from such areas shall be stipulated.” & Chr(13)+Chr(10) & _““& Chr(13)+Chr(10) & _“In order to detect deterioration, the condition of product in stock shall be assessed at appropriate intervals”

Case “4.15.4 Packaging”

Text1.Text= “The supplier shall control packing, packaging, and marking processes (including materials used) to the extent necessary to ensure conformance to specified requirements”

Case “4.15.6 Delivery”

Text1.Text= “The supplier shall apply appropriate methods for preservation and segregation of product when the product is under the supplier's control”

Case “4.16 Control of Quality Records”

Text1.Text= “The supplier shall arrange for the protection of the quality of product after final inspection and test. Where contractually specified, this protection shall be extended to include delivery to destination.” & Chr(13)+Chr(10) & _“The supplier shall establish and maintain documented procedures for identification, collection, indexing, access, filing, storage, maintenance, and disposition of quality records. Quality records shall be maintained to demonstrate conformance to specified requirements and the effective operation of the quality system. Pertinent quality records from the subcontractor shall be an element of these data. All quality records shall be legible and shall be stored and retained in such a way that they are readily retrievable in facilities that provide a suitable environment to prevent damage or deterioration and to prevent loss. Retention times of quality records shall be established and recorded. Where agreed contractually, quality records shall be made available for evaluation by the customer or the customer's representative for an agreed period.” & Chr(1 3) +Chr(1 0) & ““& Chr(13)+Chr(10) & _

“NOTE 19: Records may be in the form of any type of media, such as hard copy or electronic media”

Case “4.17 Internal Quality Audits”

Text1.Text= “The supplier shall establish and maintain documented procedures for planning and implementing internal quality audits to verify whether quality activities and related results comply with planned arrangements arid to determine the effectiveness of the quality system. Internal quality audits shall be scheduled on the basis of the status and importance of the activity to be audited and shall be carried out by personnel independent of those having direct responsibility for the activity being audited. The results of the audits shall be recorded (see 4.16) and brought to the attention of the personnel having responsibility in the area audited. The management personnel responsible for the area shall take timely corrective action on deficiencies found during the audit. Follow-up audit activities shall verify and record the implementation and effectiveness of the corrective action taken (see 4.16). NOTES 20 The results of internal quality audits form an integral part of the input to” & _“management review activities (see 4.1.3). 21 Guidance on quality-system audits is given in ANSI/ ISO/ASQC QIOOI 1-1-1994, ANSIASO/ASQC QIOO112-1994, and ANMSO/ASQC QIOOI 1-3-1994”

Case “4.18 Training”

Text1.Text= “The supplier shall establish and maintain documented procedures for identifying training needs and provide for the training of all personnel performing activities affecting quality. Personnel performing specific assigned tasks shall be qualified on the basis of appropriate education, training and/or experience, as required. Appropriate records of training shall be maintained (see 4.16)”

Case “4.19 Servicing”

Text1.Text= “Where servicing is a specified requirement, the supplier shall establish and maintain documented procedures for performing, verifying, and reporting that the servicing meets the specified requirements”

Case “4.20.1 Identification of Need of Statistical Techniques”

Text1.Text= “The supplier shall identify the need for statistical techniques required for establishing, controlling, and verifying process capability and product characteristics”

Case “4.20.2 Procedures of Applications of Statistical Techniques”

Text1.Text= “The supplier shall establish and maintain documented procedures to implement and control the application of the statistical techniques identified in 4.20. 1”

End Select

End Select

```
Text1.Text = Text2 & Combo1.Text & “” & Chr(13) + Chr(10) & Text1.Text
If Combo1.Text = “Exit” Then
  Form2.Hide
  Unload Form2
Else
```

If (Combo1.Text <> “Please use the light grey window bellow to

nevigate” And _{—}

Combo1.Text <> “Click on the right to nevigate”) Then
On Error Resume Next
MkDir (Qcdir & “\” & Combo1.Text & “\”)
L = 1
Do Until L = 31
On Error Resume Next
Open Qcdir & “\” & Combo1.Text & “\” & “sub_cat_” & Str(L) & “.txt” For

Input As #L

L = L + 1
Loop
I = 1
Do Until I = 31

```
Line Input #I, Sub_Cat_Name$(I)
If (I > 10 And I < 21) Then
  j = I − 10
Else
  If (I > 20) Then
  j = I − 20
  Else
  j = I
  End If
End If
Command2(I − 1).Caption = Str(j) & “_” & Mid(Sub_Cat_Name$(I), 4,
```

8)
I = I + 1

Loop

Else
End If
End If
Label1.Caption = Combo1.Text
Exit Sub

End Sub
Private Sub Cammand2_Click(Index As Integer)
Dim Sub_Cat_Name$(30)
Dim App As String
Dim ARC As String
If (Combo1.Text <> “Please use the light grey window bellow to nevigate”
And _{—}

```
Combo1.Text <> “Click on the right to nevigate”) Then
If (Index > 9 And Index < 20) Then
  j = Index − 9
  current_file_name = Qcdir & “\” & _{—}
  Combo1.Text & “\record” & Str(j) & “_” & Combo1.Text & “.” &_{—}
```

Right(File1.FileName, 3)
ar_file = Qcdir & “\archive\” &_{—}
“record” & Str(j) &“_” & Combo1.Text & “.” &_{—}
Right(File1.FileName, 3)

```
  current f_n_txt = Qcdir & “\” & Combo1.Text & “\” & _{—}
  “sub_cat_” & Str(j) & “.txt”
Else
  If (Index > 19) Then
```

j = Index − 19
current_file_name = Qcdir & “\” &_{—}
Combo1.Text & “\procedure” & Str(j) & “_” & Combo1.Text & “.” &_{—}
Right(File1.FileName, 3)
ar_file = Qcdir & “\archive\” &_{—}
“procedure” & Str(j) & “_” & Combo1.Text & “.” &_{—}
Right(File1.FileName, 3)
current f_n_txt = Qcdir & “\” & Combo1.Text & “\” &_{—}
“sub_cat_” & Str(j) & “.txt”

Else

j = Index + 1
current_file_name = Qcdir & “\” &_{—}
Combo1.Text & “\policy” & Str(j) &“_” & Combo1.Text & “.” &_{—}
Right(File1.FileName, 3)
ar_file = Qcdir & “\archive\” &_{—}
“policy” & Str(j) & “_” & Combo1.Text & “.” &_{—}
Right(File1.FileName, 3)
current_f_n_txt = Qcdir & “\” & Combo1.Text & “\” &_{—}
“sub_cat_” & Str(j) & “.txt”

End If

```
  End If
  Else
```

MsgBox (“Please use the light grey window to choose a file category.”),, “”
Exit Sub

End If
On Error GoTo NoFileThere0

GetAttr (current_file_name)

```
If (MsgBox(“This procedure exists in the current structure. Would you like to
update it with the file you've just choosen?”, vbYesNo, “Question Box”) =
vbYes) Then
  SetAttr current_file_name, vbNormal
  App = Str(Month(Now)) & “_” & Str(Day(Now)) & _{—}
```

“_” & Str(Year(Now)) & “_” & Str(Hour(Now)) & _{—}
“_” & Str(Minute(Now)) & “_” & Str(Second(Now))

```
  ARC = ar_file & App
  FileCopy current_file_name, ARC
  SetAttr ARC, vbReadOnly
  GoTo NoFileThere0
Else
End If
Exit Sub
NoFileThere0:
If File1.FileName <> “” Then
FileCopy File1.Path & “\” & File1.FileName, current_file_name
SetAttr current_file_name, vbReadOnly
MsgBox (“File Built into the structure”),, _{—}
```

“Please Click OK to continue”

```
  K = Index + 1
  On Error Resume Next
  Close #K
  Open Qcdir & “\” & Combo1.Text & “\” & “sub_cat_” & Str(K) & “.txt” For
  Output As #K
  Print #K, Right(File1.FileName, 3) & RichTextBox1.Text
  Close #K
  If (K > 10 And K < 21) Then
```

j = K − 10
Else
If (K > 20) Then

J = K − 20

Else

j = K

End If
End If

Open Qcdir & “\” & Combo1.Text & “\” & “sub_cat_” & Str(K) & “.txt” For

Input As #K

Line Input #K, Sub_Cat_Name$(K)
Command2(Index).Caption = Str(j) & “_” & Mid(Sub_Cat_Name$(Index + 1),

4, 8)

Close #K

Else
MsgBox (“File not Chosen”), , _{—}

“Please select a File”

End If
Exit Sub
End Sub
Private Sub Dir1_Change()

File1.Path = Dir1.Path

End Sub
Private Sub Drive1_Change()
On Error GoTo No_drive_1

Dir1.Path = Drive1.Drive
Exit Sub

No_drive_1:
Msg Box (“Please load disk and then retry.”),, “”
Exit Sub
End Sub

In an embodiment, the source code for Version 5.00 of the embodiment illustrated in FIG. 2 is as follows:

Begin VB.Form Form3

| | |
|---|---|
| Auto Redraw | = −1 ‘True |
| BackColor | = &H00404040& |
| BorderStyle | = 0 ‘None |
| Caption | = “Quality Systems Administrator” |
| ClientHeight | = 6765 |
| ClientLeft | = 0 |
| ClientTop | = 0 |
| ClientWidth | = 8430 |
| FillStyle | = 0 ‘Solid |
| FontTransparent | = 0 ‘False |
| LinkTopic | = “Form3” |
| MaxButton | = 0 ‘False |
| MinButton | = 0 ‘False |
| ScaleHeight | = 6765 |
| ScaleWidth | = 8430 |
| ShowInTaskbar | = 0 ‘False |
| StartUpPosition | = 2 ‘CenterScreen |

Begin VB.PictureBox Picture1

| | |
|---|---|
| Appearance | = 0 ‘Flat |
| BackColor | = &H80000005& |
| FillColor | = &H8000000F& |
| FillStyle | = 0 ‘Solid |
| ForeColor | = &H80000008& |
| Height | = 495 |
| Index | = 2 |
| Left | = 6600 |
| Picture | = “Main.frx”:0000 |
| ScaleHeight | = 465 |
| ScaleWidth | = 585 |
| TabIndex | = 5 |
| Top | = 4680 |
| Width | = 615 |

End
Begin VB.PictureBox Picture1

| | |
|---|---|
| Appearance | = 0 ‘Flat |
| BackColor | = &H80000005& |
| FillColor | = &H8000000F& |
| FillStyle | = 0 ‘Solid |
| ForeColor | = &H80000008& |
| Height | = 495 |
| Index | = 1 |
| Left | = 3720 |
| Picture | = “Main.frx”:00C4 |
| ScaleHeight | = 465 |
| ScaleWidth | = 585 |
| TabIndex | = 2 |
| Top | = 4680 |
| Width | = 615 |

End
Begin VB.PictureBox Picture1

| | |
|---|---|
| Appearance | = 0 ‘Flat |
| BackColor | = &H80000005& |
| FillColor | = &H8000000F& |
| FillStyle | = 0 Solid |
| ForeColor | = &H80000008& |
| Height | = 495 |
| Index | = 0 |
| Left | = 1200 |
| MousePointer | = 4 ‘Icon |
| Picture | = “Main.frx”:0188 |
| ScaleHeight | = 465 |
| ScaleWidth | = 585 |
| TabIndex | = 1 |
| Top | = 4680 |
| Width | = 615 |

End
Begin VB.Label Label3

| | |
|---|---|
| Appearance | = 0 ‘Flat |
| AutoSize | = −1 ‘True |
| BackColor | = &H80000000& |
| BackStyle | = 0 ‘Transparent |
| Caption | = “Xueshu Song and Clifford Mirman” |
| ForeColor | = &H0000FFFF& |
| Height | = 195 |
| Index | = 2 |
| Left | = 3000 |
| TabIndex | = 9 |
| Top | = 6240 |
| Width | = 2355 |

End
Begin VB.Label Label3

| | |
|---|---|
| Appearance | = 0 ‘Flat |
| AutoSize | = −1 ‘True |
| BackColor | = &H80000000& |
| BackStyle | = 0 ‘Transparent |
| Caption | = “Developed by” |
| ForeColor | = &H0000FFFF& |
| Height | = 195 |
| Index | = 0 |
| Left | = 3600 |
| TabIndex | = 8 |
| Top | = 6000 |
| Width | = 990 |

End
Begin VB.Image Image1

| | |
|---|---|
| Height | = 2355 |
| Left | = 2760 |
| Picture | = “Main.frx”:024C |
| Stretch | = −1 ‘True |
| Top | = 1680 |
| Width | = 2625 |

End
Begin VB.Label Label1

| | |
|---|---|
| BackStyle | = 0 ‘Transparent |
| Caption | = “Version 1.0.0” |

BeginProperty Font

| | |
|---|---|
| Name | = “MS Sans Serif” |
| Size | = 13.5 |
| Charset | = 0 |
| Weight | = 700 |
| Underline | = 0 ‘False |
| Italic | = −1 ‘True |
| Strikethrough | = 0 ‘False |

EndProperty

| | |
|---|---|
| ForeColor | = &H0000FFFF& |
| Height | = 495 |
| Index | = 1 |
| Left | = 3120 |
| TabIndex | = 7 |
| Top | = 1320 |
| Width | = 2175 |

End
Begin VB.Label Label2

| | |
|---|---|
| BackStyle | = 0 ‘Transparent |
| Caption | = “Exit” |
| BeginProperty Font | |

| | |
|---|---|
| Name | = “MS Sans Serif” |
| Size | = 13.5 |
| Charset | = 0 |
| Weight | = 700 |
| Underline | = 0 ‘False |
| Italic | = −1 ‘True |
| Strikethrough | = 0 ‘False |

| End Property | |
|---|---|
| ForeColor | = &H0000FFFF& |
| Height | = 495 |
| Index | = 2 |
| Left | = 6480 |
| TabIndex | = 6 |
| Top | = 5280 |
| Width | = 855 |

End
Begin VB.Label Label2

| | |
|---|---|
| BackStyle | = 0 ‘Transparent |
| Caption | = “Existing Project” |

BeginProperty Font

| | |
|---|---|
| Name | = “MS Sans Serif” |
| Size | = 13.5 |
| Charset | = 0 |
| Weight | = 700 |
| Underline | = 0 ‘False |
| Italic | = −1 ‘True |
| Strikethrough | = 0 ‘False |

| EndProperty | |
|---|---|
| ForeColor | = &H0000FFFF& |
| Height | = 495 |
| Index | = 1 |
| Left | = 2880 |
| TabIndex | = 4 |
| Top | = 5280 |
| Width | = 2535 |

End
Begin VB.Label Label2

| | |
|---|---|
| BackStyle | = 0 ‘Transparent |
| Caption | = “New Project” |

BeginProperty Font

| | |
|---|---|
| Name | = “MS Sans Serif” |
| Size | = 13.5 |
| Charset | = 0 |
| Weight | = 700 |
| Underline | = 0 ‘False |
| Italic | = −1 ‘True |
| Strikethrough | = 0 ‘False |

| End Property | |
|---|---|
| ForeColor | = &H0000FFFF& |
| Height | = 495 |
| Index | = 0 |
| Left | = 600 |
| TabIndex | = 3 |
| Top | = 5280 |
| Width | = 2055 |

End
Begin VB.Label Label1

| | |
|---|---|
| BackStyle | = 0 ‘Transparent |
| Caption | = “Quality Systems Administrator” |

BeginProperty Font

| | |
|---|---|
| Name | = “MS Sans Serif” |
| Size | = 24 |
| Charset | = 0 |
| Weight | = 700 |
| Underline | = 0 ‘False |
| Italic | = −1 ‘True |
| Strikethrough | = 0 ‘False |

| End Property | |
|---|---|
| ForeColor | = &H0000FFFF& |
| Height | = 735 |
| Index | = 0 |
| Left | = 600 |
| TabIndex | = 0 |
| Top | = 600 |
| Width | = 7215 |

End
End
Attribute VB_Name = “Form3”
Attribute VB_GlobalNameSpace = False
Attribute VB_Creatable = False
Attribute VB_PredeclaredId = True
Attribute VB_Exposed = False
Private Sub Picture1_Click(Index As Integer)

Select Case Index

Case 0

Unload Form3
Form3.Hide
Form1.Show

Case 1

Unload Form3
Form3.Hide
Form4.Show

Case 2

Unload Form3
Form3.Hide

End Select

End Sub

In an embodiment, the source code of another embodiment illustrated in FIG. 3 (Form 4: exist.frm) is as follows:

Begin VB.Form Form4

| | |
|---|---|
| BackColor | = &H00004000& |
| BorderStyle | = 0 ‘None |
| Caption | = “Existing Project” |
| ClientHeight | = 6765 |
| ClientLeft | = 0 |
| ClientTop | = 0 |
| ClientWidth | = 8430 |
| LinkTopic | = “Form4” |
| MaxButton | = 0 ‘False |
| MinButton | = 0 ‘False |
| ScaleHeight | = 6765 |
| ScaleWidth | = 8430 |
| ShowInTaskbar | = 0 ‘False |
| StartUpPosition | = 2 ‘CenterScreen |

Begin VB.Command Button Command 1

| | |
|---|---|
| BackColor | = &H00FF8080& |
| Caption | = “Return to Main Menu” |
| Height | = 375 |
| Left | = 2760 |
| Style | = 1 ‘Graphical |
| TabIndex | = 5 |
| Top | = 1680 |
| Width | = 5535 |

End
Begin VB.TextBox Text1

| | |
|---|---|
| BackColor | = &H00C0FFFF& |
| Height | = 4455 |
| Left | = 120 |
| MultiLine | = −1 ‘True |
| ScrollBars | = 2 ‘Vertical |
| TabIndex | = 4 |
| Text | = “exist.frx”:0000 |
| Top | = 2160 |
| Width | = 8175 |

End
Begin VB.TextBox Text3

| | |
|---|---|
| BackColor | = &H00FFFF00& |
| Height | = 1455 |
| Left | = 1920 |
| MultiLine | = −1 ‘True |
| TabIndex | = 3 |
| Text | = “exist.frx”:09D5 |
| Top | = 120 |
| Width | = 4935 |

End
Begin VB.CommandButton Command2

| | |
|---|---|
| BackColor | = &H00C0C0C0& |
| Caption | = “Select Directory and Continue” |
| Height | = 375 |
| Left | = 120 |
| Style | = 1 ‘Graphical |
| TabIndex | = 2 |
| Top | = 1680 |
| Width | = 2655 |

End
Begin VB.DriveListBox Drive1

| | |
|---|---|
| BackColor | = &H000000FF& |
| Height | = 315 |
| Left | = 120 |
| TabIndex | = 1 |
| Top | = 120 |
| Width | = 1815 |

End
Begin VB.DirListBox Din

| | |
|---|---|
| BackColor | = &H00FF0000& |
| Height | = 1215 |
| Left | = 120 |
| TabIndex | = 0 |
| Top | = 360 |
| Width | = 1815 |

End
Begin VB.Image Image1

| | |
|---|---|
| BorderStyle | = 1 ‘Fixed Single |
| Height | = 1455 |
| Left | = 6840 |
| MouseIcon | = “exist.frx”:0AEA |
| MousePointer | = 4 ‘Icon |
| Picture | = “exist.frx”:0C3C |
| Stretch | = −1 ‘True |
| ToolTipText | = “Click to Continue” |
| Top | = 120 |
| Width | = 1425 |

End
End
Attribute VB_Name = “Form4”
Attribute VB_GlobalNameSpace = False
Attribute VB_Creatable = False
Attribute VB_PredeclaredId = True
Attribute VB_Exposed = False
Private Sub Command1_Click()
Unload Form4
Form4.Hide
Load Form3
Form3.Show
End Sub
Private Sub Command2_Click()

Qcdir = Dir1.Path

Unload Form4
Load Form2
Form4.Hide
Form2.Show

End Sub
Private Sub Drive1_Change()

On Error GoTo DiskError

Dir1.Path = Drive1.Drive

Exit Sub

DiskError:

MsgBox (“The disk is not ready.”) , , _{—}
“Disk Not Ready”

Resume Stop Trying
Stop Trying:
End Sub

In an embodiment, the source code for a Viewer Form embodiment illustrated in FIG. 11 is as follows: Type=Exe Form=file_viewer_1.frm Reference=*G{00020430-0000-0000-C000000000000046}#2.0#0#. \\WINDOWS\SYSTEM\STDOLE2.TLB#OLE Automation Form=cover.frm Module=Modulel; Modulel_viewer. bas Object={3B7C8863-D78F-101 B-B9B5-04021 C009402}#1.2#0; RICHTX32.OCX IconForm=“Form2” Startup=“Sub Main” HelpFile=”” Command32=”” Name=“Project1” HelpContextlD=“0” CompatibleMode=“0” MajorVer=1 MinorVer=0 RevisionVer=0 AutolncrementVer=0 ServerSupportFiles=0 VersionCompanyName=“NIU” CompilationType=0 OptimizationType=0 FavorPentiumPro(tm)=0 CodeViewDebug Info=0 NoAliasing=0 BoundsCheck=0 OverflowCheck=0 FlPointCheck=0 FDIVCheck=0 UnroundedFP=0 StartMode=0 Unattended=0 Retained=0 ThreadPerObject=0 MaxNumberOffhreads=1 VERSION 5.00

Begin VB.Form Form2

| | |
|---|---|
| AutoRedraw | =−1 True |
| BackColor | =&H00004000& |
| BorderStyle | =0 ‘None |
| Caption | =“ANSI/ISO/ASQC 09001-1994 4.1.1” |
| ClientHeight | =7140 |
| ClientLeft | =4245 |
| ClientTop | =1920 |
| ClientWidth | =8625 |
| LinkTopic | =“Form1” |
| MaxButton | =0 ‘False |
| MmButton | =0 ‘False |
| ScaleHeight | =7140 |
| ScaleWidth | =8625 |
| ShowInTaskbar | =0 ‘False |
| StartUpPosition | =2 ‘CenterScreen |

| Begin VB.TextBox Text2 | |
|---|---|
| Height | =1335 |
| Left | =3360 |
| TabIndex | =39 |
| Text | =“This will show the fille builder's comments, |
| | if any.” |
| Top | =120 |
| Width | =3735 |

End
Begin VB.DriveListBox Drive1

| | |
|---|---|
| Height | =315 |
| Left | =120 |
| TabIndex | =37 |
| Top | =120 |
| Width | =3135 |

End
Begin VB.CommandButton Command2

| | |
|---|---|
| BackColor | =&H00C000C0& |
| Caption | =“10” |
| Height | =375 |
| Index | =29 |
| Left | =6840 |
| Style | =1 ‘Graphical |
| TabIndex | =33 |
| Top | =6600 |
| Width | =1695 |

End
Begin VB.CommandButton Command2

| | |
|---|---|
| BackColor | =&H00C000C0& |
| Caption | =“9” |
| Height | =375 |
| Index | =28 |
| Left | =5160 |
| Style | =1 ‘Graphical |
| TabIndex | =32 |
| Top | =6600 |
| Width | =1695 |

End
Begin VB.CommandButton Command2

| | |
|---|---|
| BackColor | =&H00C000C0& |
| Caption | =“8” |
| Height | =375 |
| Index | =27 |
| Left | =3480 |
| Style | =1 ‘Graphical |
| TabIndex | =31 |
| Top | =6600 |
| Width | =1695 |

End
Begin VB.CommandButton Command2

| | |
|---|---|
| BackColor | =&H00C000C0& |
| Caption | =“7” |
| Height | =375 |
| Index | =26 |
| Left | =1800 |
| Style | =1 ‘Graphical |
| TabIndex | =30 |
| Top | =6600 |
| Width | =1695 |

End
Begin VB.CommandButton Command2

| | |
|---|---|
| BackColor | =&H00C000C0& |
| Caption | =“6” |
| Height | =375 |
| Index | =25 |
| Left | =120 |
| Style | =1 ‘Graphical |
| TabIndex | =29 |
| Top | =6600 |
| Width | =1695 |

End
Begin VB.CommandButton Command2

| | |
|---|---|
| BackColor | =&H000000C0& |
| Caption | =“5” |
| Height | =375 |
| Index | =24 |
| Left | =6840 |
| Style | =1 ‘Graphical |
| TabIndex | =28 |
| Top | =6240 |
| Width | =1695 |

End
Begin VB.CommandButton Command2

| | |
|---|---|
| BackColor | =&H00C000C0& |
| Caption | =“4” |
| Height | =375 |
| Index | =23 |
| Left | =5160 |
| Style | =1 ‘Graphical |
| TabIndex | =27 |
| Top | =6240 |
| Width | =1695 |

End
Begin VB.CommandButton Command2

| | |
|---|---|
| BackColor | =&H000000C0& |
| Caption | =“3” |
| Height | =375 |
| Index | =22 |
| Left | =3480 |
| Style | =1 ‘Graphical |
| TabIndex | =26 |
| Top | =6240 |
| Width | =1695 |

End
Begin VB.CommandButton Command2

| | |
|---|---|
| BackColor | =&H00C000C0& |
| Caption | =“2” |
| Height | =375 |
| Index | =21 |
| Left | =1800 |
| Style | =1 ‘Graphical |
| TabIndex | =25 |
| Top | =6240 |
| Width | =1695 |

End
Begin VB.CommandButton Command2

| | |
|---|---|
| BackColor | =&H00C000C0& |
| Caption | =“1” |
| Height | =375 |
| Index | =20 |
| Left | =120 |
| Style | =1 ‘Graphical |
| TabIndex | =24 |
| Top | =6240 |
| Width | =1695 |

End
Begin VB.CommandButton Command2

| | |
|---|---|
| BackColor | =&H00FFFF00& |
| Caption | =“10” |
| Height | =375 |
| Index | =19 |
| Left | =6840 |
| Style | =1 ‘Graphical |
| TabIndex | =23 |
| Top | =5640 |
| Width | =1695 |

End
Begin VB.CommandButton Command2

| | |
|---|---|
| BackColor | =&H00FFFF00& |
| Caption | =“9” |
| Height | =375 |
| Index | =18 |
| Left | =5160 |
| Style | =1 ‘Graphical |
| TabIndex | =22 |
| Top | =5640 |
| Width | =1695 |

End
Begin VB.CommandButton Command2

| | |
|---|---|
| BackColor | =&H00FFFF00& |
| Caption | =“8” |
| Height | =375 |
| Index | =17 |
| Left | =3480 |
| Style | =1 ‘Graphical |
| TabIndex | =21 |
| Top | =5640 |
| Width | =1695 |

End
Begin VB.Command Button Command2

| | |
|---|---|
| BackColor | =&H00FFFF00& |
| Caption | =“7” |
| Height | =375 |
| Index | =16 |
| Left | =1800 |
| Style | =1 ‘Graphical |
| TabIndex | =20 |
| Top | =5640 |
| Width | =1695 |

End
Begin VB.CommandButton Command2

| | |
|---|---|
| BackColor | =&H00FFFF00& |
| Caption | =“6” |
| Height | =375 |
| Index | =15 |
| Left | =120 |
| Style | =1 ‘Graphical |
| TabIndex | =19 |
| Top | =5640 |
| Width | =1695 |

End
Begin VB.CommandButton Command2

| | |
|---|---|
| BackColor | =&H00FFFF80& |
| Caption | =“5” |
| Height | =375 |
| Index | =14 |
| Left | =6840 |
| Style | =1 ‘Graphical |
| TabIndex | =18 |
| Top | =5280 |
| Width | =1695 |

End
Begin VB.CommandButton Command2

| | |
|---|---|
| BackColor | =&H00FFFF00& |
| Caption | =“4” |
| Height | =375 |
| Index | =13 |
| Left | =5160 |
| Style | =1 ‘Graphical |
| TabIndex | =17 |
| Top | =5280 |
| Width | =1695 |

End
Begin VB.CommandButton Command2

| | |
|---|---|
| BackColor | =&H00FFFF00& |
| Caption | =“3” |
| Height | =375 |
| Index | =12 |
| Left | =3480 |
| Style | =1 ‘Graphical |
| TabIndex | =16 |
| Top | =5280 |
| Width | =1695 |

End
Begin VB.CommandButton Command2

| | |
|---|---|
| BackColor | =&H00FFFF00& |
| Caption | =“2” |
| Height | =375 |
| Index | =11 |
| Left | =1800 |
| Style | =1 ‘Graphical |
| TabIndex | =15 |
| Top | =5280 |
| Width | =1695 |

End
Begin VB.Command Button Command2

| | |
|---|---|
| BackColor | =&H00FFFF00& |
| Caption | =“1” |
| Height | =375 |
| Index | =10 |
| Left | =120 |
| Style | =1 ‘Graphical |
| TabIndex | =14 |
| Top | =5280 |
| Width | =1695 |

End
Begin VB.CommandButton Command2

| | |
|---|---|
| BackColor | =&H000080FF& |
| Caption | =“10” |
| Height | =375 |
| Index | =9 |
| Left | =6840 |
| Style | =1 ‘Graphical |
| TabIndex | =13 |
| Top | =4680 |
| Width | =1695 |

End
Begin VB.CommandButton Command2

| | |
|---|---|
| BackColor | =&H000080FF& |
| Caption | =“9” |
| Height | =375 |
| Index | =8 |
| Left | =5160 |
| Style | =1 ‘Graphical |
| TabIndex | =12 |
| Top | =4680 |
| Width | =1695 |

End
Begin VB.CommandButton Command2

| | |
|---|---|
| BackColor | =&H000080FF& |
| Caption | =“8” |
| Height | =375 |
| Index | =7 |
| Left | =3480 |
| Style | =1 ‘Graphical |
| TabIndex | =11 |
| Top | =4680 |
| Width | =1695 |

End
Begin VB.CommandButton Command2

| | |
|---|---|
| BackColor | =&H000080FF& |
| Caption | =“7” |
| Height | =375 |
| Index | =6 |
| Left | =1800 |
| Style | =1 ‘Graphical |
| TabIndex | =10 |
| Top | =4680 |
| Width | =1695 |

End
Begin VB.CommandButton Command2

| | |
|---|---|
| BackColor | =&H000080FF& |
| Caption | =“6” |
| Height | =375 |
| Index | =5 |
| Left | =120 |
| Style | =1 ‘Graphical |
| TabIndex | =9 |
| Top | =4680 |
| Width | =1695 |

End
Begin VB.CommandButton Command2

| | |
|---|---|
| BackColor | =&H000080FF& |
| Caption | =“5” |
| Height | =375 |
| Index | =4 |
| Left | =6840 |
| Style | =1 ‘Graphical |
| TabIndex | =8 |
| Top | =4320 |
| Width | =1695 |

End
Begin VB.CommandButton Command2

| | |
|---|---|
| BackColor | =&H000080FF& |
| Caption | =“4” |
| Height | =375 |
| Index | =3 |
| Left | =5160 |
| Style | =1 ‘Graphical |
| TabIndex | =7 |
| Top | =4320 |
| Width | =1695 |

End
Begin VB.CommandButton Command2

| | |
|---|---|
| BackColor | =&H000080FF& |
| Caption | =“3” |
| Height | =375 |
| Index | =2 |
| Left | =3480 |
| Style | =1 ‘Graphical |
| TabIndex | =6 |
| Top | =4320 |
| Width | =1695 |

End
Begin VB.CommandButton Command2

| | |
|---|---|
| BackColor | =&H000080FF& |
| Caption | =“2” |
| Height | =375 |
| Index | =1 |
| Left | =1800 |
| Style | =1 ‘Graphical |
| TabIndex | =5 |
| Top | =4320 |
| Width | =1695 |

End
Begin VB.ComboBox Combo 1

| | |
|---|---|
| BackColor | =&H00C0C0C0& |
| Height | =315 |
| ItemData | =“file_viewer_1.frx”:0000 |
| Left | =120 |
| List | =“file_viewer_1 .frx”:00B5 |
| TabIndex | =3 |
| Text | =“Click on the right to nevigate” |
| Top | =3600 |
| Width | =8415 |

End
Begin VB.CommandButton Command2

| | |
|---|---|
| BackColor | =&H000080FF& |
| Caption | =“1” |
| Height | =375 |
| Index | =0 |
| Left | =120 |
| Style | =1 ‘Graphical |
| TabIndex | =2 |
| Top | =4320 |
| Width | =1695 |

End
Begin VB.TextBox Text1

| | |
|---|---|
| BackColor | =&H00C0C000& |
| Height | =1695 |
| Left | =120 |
| MultiLine | =−1 ‘True |
| ScrollBars | =2 ‘Vertical |
| TabIndex | =1 |
| Text | =“file viewer 1.frx”:08E2 |
| Top | =1560 |
| Width | =8415 |

End
Begin VB.DirListBox Din

| | |
|---|---|
| BackColor | =&H00FF8080& |
| Height | =990 |
| Left | =120 |
| TabIndex | =0 |
| Top | =480 |
| Width | =3135 |

End
Begin VB.Image Image1

| | |
|---|---|
| BorderStyle | =1 ‘Fixed Single |
| Height | =1335 |
| Left | =7200 |
| MouseIcon | =“file_viewer_1.frx”:0989 |
| MousePointer | =4 ‘Icon |
| Picture | =“file_viewer_1.frx”:0ADB |
| Stretch | =−1 ‘True |
| ToolTipText | =“Click to Continue” |
| Top | =120 |
| Width | =1305 |

End
Begin VB.OLE OLE1

| | |
|---|---|
| Height | =615 |
| Left | =5040 |
| TabIndex | =38 |
| Top | =1680 |
| Width | =975 |

End
Begin VB.Label Label4

| | |
|---|---|
| AutoSize | =−1 ‘True |
| BackColor | =&H00FFFF00& |
| BackStyle | =0 ‘Transparent |
| Caption | =“Click to View the Record Numbered or |
| | Named as bellow:” |

BeginProperty Font

| | |
|---|---|
| Name | =“MS Sans Serif” |
| Size | =8.25 |
| Charset | =0 |
| Weight | =700 |
| Underline | =0 ‘False |
| Italic | =0 ‘False |
| Strikethrough | =0 ‘False |

| EndProperty | |
|---|---|
| ForeColor | =&H00FFFF00& |
| Height | =195 |
| Left | =1920 |
| TabIndex | =36 |
| Top | =5040 |
| Width | =4830 |

End
Begin VB.Label Label3

| | |
|---|---|
| AutoSize | =−1 ‘True |
| BackColor | =&H00C000C0& |
| BackStyle | =0 ‘Transparent |
| Caption | =“Click to View the Procedure Numbered |
| | or Named as bellow:” |

BeginProperty Font

| | |
|---|---|
| Name | =“MS Sans Serif” |
| Size | =8.25 |
| Charset | =0 |
| Weight | =700 |
| Underline | =0 ‘False |
| Italic | =0 ‘False |
| Strikethrough | =0 ‘False |

| EndProperty | |
|---|---|
| ForeColor | =&H00FF00FF& |
| Height | =195 |
| Left | =1800 |
| TabIndex | =35 |
| Top | =6000 |
| Width | =5085 |

End
Begin VB.Label Label2

| | |
|---|---|
| AutoSize | =−1 ‘True |
| BackColor | =&H000080FF& |
| BackStyle | =0 ‘Transparent |
| Caption | =“Click to View the Policy Numbered or |
| | Named as bellow:” |

BeginProperty Font

| | |
|---|---|
| Name | =“MS Sans Serif” |
| Size | =8.25 |
| Charset | =0 |
| Weight | =700 |
| Underline | =0 ‘False |
| Italic | =0 ‘False |
| Strikethrough | =0 ‘False |

| EndProperty | |
|---|---|
| ForeColor | =&H000080FF& |
| Height | =195 |
| Index | =0 |
| Left | =1920 |
| TabIndex | =34 |
| Top | =4080 |
| Width | =4725 |

End
Begin VB.Label Label1

| | |
|---|---|
| Alignment | =2 ‘Center |
| BackStyle | =0 ‘Transparent |
| Caption | =“Please use the light grey window bellow |
| | to nevigate” |

| BeginProperty Font | |
|---|---|
| Name | =“MS Sans Serif” |
| Size | =12 |
| Charset | =0 |
| Weight | =400 |
| Underline | =0 ‘False |
| Italic | =0 ‘False |
| Strikethrough | =0 ‘False |

| EndProperty | |
|---|---|
| ForeColor | =&H0000FFFF& |
| Height | =255 |
| Left | =120 |
| TabIndex | =4 |
| Top | =3240 |
| Width | =8415 |

End
End
Attribute VB_Name = “Form2”
Attribute VB_GlobalNameSpace = False
Attribute VB_Creatable = False
Attribute VB_PredeclaredId = True
Attribute VB_Exposed = False
Private Sub Combo1_Click()
M = 1
Do Until M = 31
On Error Resume Next
Close #M
M = M + 1
Loop
M = 1

Do Until M = 31
Sub_Cat_Name$(M) = “”
M = M + 1
Loop

Text=“Please read the information bellow regarding the current” & “directory your are building, and then to find the file” & “to fill in a file category, please” & Chr(13)+Chr(10) & _& Chr(13)+Chr(10) & _

“1. Use the red window to choose a drive” & Chr(13)+Chr(10) & _

“2. Use the blue window to choose a directory” & Chr(13)+Chr(1 0) & _

“3. Use the green window to choose a file” & Chr(13)+Chr(10) & _

“4. Use the light grey window to choose a category and the dark grey window to view the existing files in the chosen category” & Chr(13)+Chr(10) & _

“5. Use the yellow window to type in a user-defined file name of maximum 11 letters. Additional typing is allowed and will be saved as comments which may be viewed with the Quality Control Demonstrator” & Chr(13)+Chr(10) & _

“6. Use the numbered ‘Save as Procedure’, ‘Save as Form’, or‘Save as Document’ button to save the file into the chosen category of the file structure” & Chr(13)+Chr(10) & _““& Chr(13)+Chr(10) & _“Information regarding the current directory:” & Chr(13)+Chr(10) & 40 ” & Chr(13)+Chr(10)

Select Case Combol.Text

Case “4.1.1 Quality Policy”

Text1.Text=“The supplier's management with executive responsibility 4WI” &

“define and document its policy for quality, including” & _

“objectives for quality and its commitment to quality.” & _

“The quality policy 4WI be relevant to the supplier's ” & _

“organizational goals and the expectations and needs of its” & _

“customers. The supplier shall ensure that this policy is” & _

“understood, implemented, and maintained at all levels of” & _

“the organization”

Case “4.1.2.1 Organizational Responsibility and Authority”

Text1.Text= “The responsibility, authority, and the interrelation of personnel who manage, perform, and verify work affecting quality shall be defined and documented, particularly for personnel who need the organizational freedom and authority to:” & Chr(13)+Chr(10) & _““& Chr(13)+Chr(10) & _

“a) initiate action to prevent the occurrence of any nonconfirmities relating to product, process, and quality system;” & Chr(13)+Chr(10) & _““& Chr(13)+Chr(10) & _

“b) identify and record any problems relating to the product, process, and quality system;” & Chr(13)+Chr(10) & _” & Chr(13)+Chr(10) & _

“c) initiate, recommend, or provide solutions through designated channels;” & Chr(13)+Chr(10) & _““& Chr(13)+Chr(10) & _

“d) verify the implementation of solutions;” & Chr(13)+Chr(10) & ““&Chr(13)+Chr(10) & _

“e) control further processing, delivery, or installation of nonconforming product until the deficiency or unsatisfactory condition has been corrected”

Case “4.1.2.2 Organizational Resources”

Text1.Text= “The supplier shall identify resource requirements and provide adequate resources, including the assignment of trained personnel (see 4.18), for management, performance of work, and verification activities including internal quality audits”

Case “4.1.2.3 Management Representative”

Text1.Text= “The supplier's management with executive responsibility shall appoint a member of the supplier's own management who, irrespective of other responsibilities, shall have defined authority for” & Chr(13)+Chr(10) & _““& Chr(13)+Chr(10) & _

“a) ensuring that a quality system is established, implemented, and maintained in accordance with this American National Standard, and” & Chr(13)+Chr(10) & _““& Chr(13)+Chr(10) & _

“b) reporting on the performance of the quality system to the supplier's management for review and as a basis for improvement of the quality system.” & Chr(13)+Chr(10) & _& Chr(13)+Chr(10) & _“NOTE 5 The responsibility of a management representative may also include liaison with external parties on matters relating to the supplier's quality system”

Case “4.1.3 Management Review”

Text1.Text= “The supplier's management with executive responsibility shall review the quality system at defined intervals sufficient to ensure its continuing suitability and effectiveness in satisfying the requirements of this American National Standard and the supplier's stated quality policy and objectives (see 4.1.1). Records of such reviews shall be maintained (see 4.16)”

Case “4.2.1 General Quality Systems”

Text1.Text= “The supplier shall establish, document, and maintain a quality system as a means of ensuring that product conforms to specified requirements. The supplier shall prepare a quality manual covering the requirements of this American National Standard. The quality manual shall include or make reference to the quality-system procedures and outline the structure of the documentation used in the quality system.” & Chr(13)+Chr(10) & _““& Chr(13)+Chr(10) & _“NOTE 6: Guidance on quality manuals is given in ISO 10013”

Case “4.2.2 Quality-system Procedures”

Text1.Text= “The supplier shall” & Chr(13)+Chr(10) & _““& Chr(13)+Chr(10) & _

“a) prepare documented procedures consistent with the” & Chr(13)+Chr(10) ““& Chr(13)+Chr(10) & _“requirements of this American National Standard and the supplier's stated quality policy, and” & Chr(13)+Chr(10) & _

“b) effectively implement the quality system and its documented procedures” & Chr(13)+Chr(10) & _“For the purposes of this American National Standard, the range and detail of the procedures that form part of the quality system shall be dependent upon the complexity of the work, the methods used, and the skills and training needed by personnel involved in carrying out the activity.” & Chr(13)+Chr(10) & _““& Chr(13)+Chr(10) & _“NOTE 7 Documented procedures may make reference to work instructions that define how an activity is performed”

Case “4.2.3 Quality Planning”

Text1.Text= “The supplier shall define and document how the requirements for quality will be met. Quality planning shall be consistent with all other requirements of a supplier's quality system and shall be documented in a format to suit the supplier's method of operation. The supplier shall give consideration to the following activities, as appropriate, in meeting the specified requirements for products, projects, or contracts:” & Chr(13)+Chr(10) & _

“a) the preparation of quality plans;” & Chr(13)+Chr(10) &

“b) the identification and acquisition of any controls,” & _“processes, equipment (including inspection and test equipment), fixtures, resources, and skills that may be needed to achieve the required quality;” & Chr(13)+Chr(10) & _

“c) ensuring the compatibility of the design, the production process, installation, servicing, inspection and test procedures, and the applicable documentation;” & Chr(13)+Chr(10) & _

“d) the updating, as necessary, of quality control, inspection, and testing techniques, including the development of new instrumentation;” & Chr(1 3) +Chr(10) & _

“e) the identification of any measurement requirement involving capability that exceeds the known state of the art, in sufficient time for the needed capability to be developed;” & Chr(13)+Chr(10) & _

“f) the identification of suitable verification at appropriate stages in the realization of product;” & Chr(13)+Chr(10) & _

“g) the clarification of standards of acceptability for all features and requirements, including those which contain a subjective element;” & Chr(1 3) +Chr(10) & _

“h) the identification and preparation of quality records (see 4.16).” & Chr(13) +Chr(10) & _“NOTE 8 The quality plans referred to (see 4.2.3a) may” & Chr(13)+Chr(10) “be in the form of a reference to the appropriate documented procedures that form an integral part of the supplier's quality system”

Case “4.3.1 General Contract Review”

Text1.Text= “The supplier shall establish and maintain documented procedures for contract review and for the coordination of these activities”

Case “4.3.2 Review of Contract”

Text1.Text= “Before submission of a tender, or at the acceptance of a contract or order (statement of requirement), the tender, contract, or order shall be reviewed by the supplier to ensure that:” & Chr(13)+Chr(10) & _““& Chr(13)+Chr(10) & _

“a) the requirements are adequately defined and documented; where no written statement of requirement is available for an order received by verbal means, the supplier shall ensure that the order requirements are agreed before their acceptance;” & Chr(1 3) +Chr(1 0) & _““& Chr(13)+Chr(10) & _

“b) any differences between the contract or accepted order requirements and those in the tender are resolved;” & Chr(13)+Chr(10) & _““& Chr(13)+Chr(10) & _

“c) the supplier has the capability to meet the contract or” & Chr(1 3) +Chr(1 0) & _“accepted order requirements”

Case “4.3.3 Amendment to Contract”

Text1.Text= “The supplier shall identify how an amendment to a contract is made and correctly transferred to the functions concerned within the supplier's organization”

Case “4.3.4 Records of Contract”

Text1.Text= “Records of contract reviews shall be maintained (see 4.16).” & Chr(13)+Chr(10) & _“NOTE 9: Channels for communication and interfaces with the customer's organization in these contract matters should be established”

Case “4.4.1 General Design Control”

Text1.Text= “The supplier shall establish and maintain documented procedures to control arid verify the design of the product in order to ensure that the specified requirements are met”

Case “4.4.2 Design and Development Planning”

Text1.Text= “The supplier shall prepare plans for each design and development activity. The plans shall describe or reference these activities, and define responsibility for their implementation. The design and development activities shall be assigned to qualified personnel equipped with adequate resources. The plans shall be updated, as the design evolves”

Case “4.4.3 Organizational and Technical Interfaces”

Text1.Text= “Organizational and technical interfaces between different groups which input into the design process shall be defined and the necessary information documented, transmitted, and regularly reviewed”

Case “4.4.4 Design Input”

Text1.Text= “Design-input requirements relating to the product, including applicable statutory and regulatory requirements, shall be identified, documented, and their selection reviewed by the supplier for adequacy. Incomplete, ambiguous, or conflicting requirements shall be resolved with those responsible for imposing these requirements”

Case “4.4.5 Design Output”

Text1.Text= “Design output shall be documented and expressed in terms that can be verified against design-input requirements and validated (see 4.4.8).” & Chr(13)+Chr(10) & _“Design output shall:” & Chr(13)+Chr(10) & _““& Chr(13)+Chr(10) & _

“a) meet the design-input requirements;” & Chr(13)+Chr(10) & _““& Chr(13)+Chr(10) & _

“b) contain or make reference to acceptance criteria;” & Chr(13)+Chr(1l0) & ““& Chr(13)+Chr(10) & _

“c) identify those characteristics of the design that are crucial to the safe and proper functioning of the product (e.g., operating, storage, handling, maintenance, and disposal requirements).” & Chr(13)+Chr(10) & _““& Chr(13)+Chr(10) & _“Design-output documents shall be reviewed before release”

Case “4.4.6 Design Review”

Text1.Text= “At appropriate stages of design, formal documented reviews of the design results shall be planned and conducted. Participants at each design review shall include representatives of all functions concerned with the design stage being reviewed, as well as other specialist personnel, as required. Records of such reviews shall be maintained (see 4.16)”

Case “4.4.7 Design Verification”

Text1.Text= “At appropriate stages of design, design verification shall be performed to ensure that the design-stage output meets the design-stage input requirements. The design-verification measures shall be recorded (see 4.16).” & Chr(13)+Chr(10) & _““& Chr(13)+Chr(10) & _

“NOTE 10: In addition to conducting design reviews (see 4.4.6), design verification may include activities such as” & Chr(13)+Chr(10) & _Chr(13)+Chr(10) & _

“a) performing alternative calculations,” & Chr(13)+Chr(10) & _““& Chr(13)+Chr(10) & _

“b) comparing the new design with a similar proven design, if available,” & Chr(13)+Chr(10) & _““& Chr(13)+Chr(10) & _

“c) undertaking tests and demonstrations, and” & Chr(13)+Chr(10) & _““& Chr(13)+Chr(10) & _

“d) reviewing the design-stage documents before release”

Case “4.4.8 Design Validation”

Text1.Text= “Design validation shall be performed to ensure that product conforms to defined user needs and/or requirements.” & Chr(13)+Chr(10) & _

“NOTES” & Chr(13)+Chr(10) & _“11: Design validation follows successful design verification (see 4.4.7).” & Chr(13)+Chr(10) & _“12: Validation is normally performed under defined operating conditions.” & Chr(13)+Chr(10) & _“13: Validation is normally performed on the final product, but may be necessary in earlier stages prior to product completion.” & Chr(13)+Chr(10) & _“14: Multiple validations may be performed if there are different intended uses”

Case “4.4.9 Design Changes”

Text1.Text= “All design changes and modifications shall be identified, documented, reviewed, and approved by authorized personnel before their implementation”

Case “4.5.1 General Document and Data Control”

Text1.Text= “The supplier shall establish and maintain documented procedures to control all documents and data that relate to the requirements of this American National Standard including, to the extent applicable, documents of external origin such as standards and customer drawings.” & Chr(13)+Chr(10) & _

“NOTE 15: Documents and data can be in the form of any type of media, such as hard copy or electronic media”

Case “4.5.2 Document and Data Approval and Issue”

Text1.Text= “The documents and data shall be reviewed and approved for adequacy by authorized personnel prior to issue. A master list or —equivalent document-control procedure identifying the current revision status of documents shall be established and be readily available to preclude the use” & “of invalid and/or obsolete documents.” & Chr(13)+Chr(10) & _““& Chr(13)+Chr(10) & _“This control shall ensure that:” & Chr(13)+Chr(10) & _““& Chr(13)+Chr(10) & _

“a) the pertinent issues of appropriate documents are available at all locations where operations essential to the effective functioning of the quality system are performed;” & Chr(13)+Chr(10) & _” & Chr(13)+Chr(10) & _

“b) invalid and/or obsolete documents are promptly removed from all points of issue or use, or otherwise assured against unintended use;” & Chr(13)+Chr(10) & _““& Chr(13)+Chr(10) & _

“c) any obsolete documents retained for legal and/or knowledge-preservation purposes are suitably identified”

Case “4.5.3 Document and Data Changes”

Text1.Text= “Changes to documents and data shall be reviewed and approved by the same functions/organizations that performed the original review and approval, unless specifically designated otherwise. The designated functions/ organizations shall have access to pertinent background information upon which to base their review and approval.” & Chr(13)+Chr(10) & _““& Chr(13)+Chr(10) & _“Where practicable, the nature of the change shall be identified in the document or the appropriate aftachments”

Case “4.6.1 General Purchasing”

Text1.Text= “The supplier shall establish and maintain documented procedures to ensure that purchased product (see 3.1) conforms to specified requirements”

Case “4.6.2 Evaluation of Subcontractors”

Text1.Text= “The supplier shall:” & Chr913)+Chr(10) & ““& Chr(13)+Chr(10) & _

“a) evaluate and select subcontractors on the basis of their ability to meet subcontract requirements including the quality system and any specific quality-assurance requirements;” & Chr(13)+Chr(10) & _& &Chr(13)+Chr(10) & _

“b) define the type and extent of control exercised by the supplier over subcontractors. This shall be dependent upon the type of product, the impact of subcontracted product on the quality of final product, and, where applicable, on the quality audit reports and/or quality records of the previously demonstrated capability and performance of subcontractors;” & Chr(13)+Chr(10) & _““& Chr(13)+Chr(10) & _

“c) establish and maintain quality records of acceptable subcontractors (see 4.16)”

Case “4.6.3 Purchasing Data”

Text1.Text= “Purchasing documents shall contain data clearly describing the product ordered, including where applicable:” & Chr(13)+Chr(10) & _““& Chr(13)+Chr(10) & _

“a) the type, class, grade, or other precise identification;” & Chr(13)+Chr(10) & _““&Chr(13)+Chr(10) & _

“b) the title or other positive identification, and applicable issues of specifications, drawings, process requirements, inspection instructions, and other relevant technical data, including requirements for approval or qualification of product, procedures, process equipment, and personnel;” & Chr(13)+Chr(10) & _““& Chr(13)+Chr(10) & _

“c) the title, number, and issue of the quality-system standard to be applied” & Chr(13)+Chr(10) & _““& Chr(13)+Chr(10) & _“The supplier shall review and approve purchasing documents for adequacy of the specified requirements prior to release”

Case “4.6.4.1 Supplier Verification at Subcontractor's Premises”

Text1.Text= “Where the supplier proposes to verify purchased product at the subcontractor's premises, the supplier shall specify verification arrangements and the method of product release in the purchasing documents”

Case “4.6.4.2 Customer Verification of Subcontracted Product”

Text1.Text= “Where specified in the contract, the supplier's customer or the customer's representative shall be afforded the right to verify at the subcontractor's premises and the supplier's premises that subcontracted product conforms to specified requirements. Such verification shall not be used by the supplier as evidence of effective control of quality by the subcontractor.” & Chr(13)+Chr(10) & _“Verification by the customer shall not absolve the supplier of the responsibility to provide acceptable product, nor shall it preclude subsequent rejection by the customer”

Case “4.7 Control of Customer-Supplied Product”

Text1.Text= “The supplier shall establish and maintain documented procedures for the control of verification, storage, and maintenance of customer-supplied product provided for incorporation into the supplies or for related activities. Any such product that is lost, damaged, or is otherwise unsuitable for use shall be recorded and reported to the customer (see 4.16)” &Chr(13)+Chr(10) & _““& Chr(13)+Chr(10) & _“Verification by the supplier does not absolve the customer of the responsibility to provide acceptable product”

Case “4.8 Product Indentification and Traceability”

Text1.Text= “Where appropriate, the supplier shall establish and maintain documented procedures for identifying the product by suitable means from receipt and during all stages of production, delivery, and installation.” & Chr(13)+Chr(10) & _““& Chr(13)+Chr(10) & _“Where and to the extent that traceability is a specified requirement, the supplier shall establish and maintain documented procedures for unique identification of individual product or batches. This identification shall be recorded (see 4.16)”

Case “4.9 Process Control”

Text1.Text= “The supplier shall identify and plan the production, installation, and servicing processes which directly affect quality and shall ensure that these processes are carried out under controlled conditions. Controlled conditions shall include the following:” & Chr(13)+Chr(10) & _

“a) documented procedures defining the manner of production, installation, and servicing, where the absence of such procedures could adversely affect quality;” & Chr(13)+Chr(10) & _

“b) use of suitable production, installation, and servicing equipment, and a suitable working environment;” & Chr(13)+Chr(10) & _

“c) compliance with reference standards/codes, quality plans, and/or documented procedures;” & Chr(13)+Chr(10) & _

“d) monitoring and control of suitable process parameters and product characteristics;” & Chr(13)+Chr(10) & _

“e) the approval of processes and equipment, as appropriate;” & Chr(13)+Chr(10) & _

“f) criteria for workmanship, which shall be stipulated in the clearest practical manner (e.g., written standards, representative samples, or illustrations);” & Chr(13)+Chr(10) & _

“g) suitable maintenance of equipment to ensure continuing process capability.” & Chr(13)+Chr(10) & _“Where the results of processes cannot be fully verified by subsequent inspection and testing of the product and where, for example, processing deficiencies may become apparent only after the product is in use, the processes shall be carried out by qualified operators and/or shall require continuous monitoring and control of process parameters to ensure that the specified requirements are met.” & Chr(13)+Chr(10) & _“The requirements for any qualification of process operations, including associated equipment and personnel (see 4.18), shall be specified.” & Chr(13) +Chr(10) & _

“NOTE 16 Such processes requiring pre qualification of their process capability are frequently referred to as special processes.” & Chr(13)+Chr(10) & _“Records shall be maintained for qualified processes, equipment, and personnel, as appropriate (see 4.16)”

Case “4.10.1 General Inspection and Testing”

Text1.Text= “The supplier shall establish and maintain documented procedures for inspection and testing activities in order to verify that the specified requirements for the product are met. 71 be required inspection and testing, and the records to be established, shall be detailed in the quality plan or documented procedures”

Case “4.10.2.1 Receiving Inspection and Testing—(Prior to Process)”

Text1.Text= “The supplier shall ensure that incoming product is not used or processed (except in the circumstances described in 4.10.2.3) until it has been inspected or otherwise verified as conforming to specified requirements. Verification of the specified requirements shall be in accordance with the quality plan and/or documented procedures”

Case “4.10.2.2 Receiving Inspection and Testing—(Recorded Evidence)”

Text1.Text= “In determining the amount and nature of receiving inspection, consideration shall be given to the amount of control exercised at the subcontractor's premises and the recorded evidence of conformance provided”

Case “4.10.2.3 Receiving Inspection and Testing—(Immediate Recall)”

Text1.Text= “Where incoming product is released for urgent production purposes prior to verification, it shall be positively identified and recorded (see 4.16) in order to permit immediate recall and replacement in the event of nonconformity to specified requirements”

Case “4.10.3 In-process Inspection and Testing”

Text1.Text= “The supplier shall:” & Chr913)+Chr(10) & ” ” & Chr(13)+Chr(10) & _

“a) inspect and test the product as required by the quality plan and/or documented procedures;” & Chr(13)+Chr(10) & _““& Chr(13)+Chr(10) & _

“b) hold product until the required inspection and tests have been completed or necessary reports have been received and verified, except when product is released under positive-recall procedures (see 4.10.2.3). Release under positive-recall procedures shall not preclude the activities outlined in 4.10.3a”

Case “4.10.4 Final Inspection and Testing”

Text1.Text= “The supplier shall carry out all final inspection and testing in accordance with the quality plan and/or documented procedures to complete the evidence of conformance of the finished product to the specified requirements.” & Chr(13)+Chr(10) & _“The quality plan and/or documented procedures for final inspection and testing shall require that all specified inspection and tests, including those specified either on receipt of product or in-process, have been carried out and that the results meet specified requirements.” & Chr913)+Chr(10) & _“No product shall be dispatched until all the activities specified in the quality plan and/or documented procedures have been satisfactorily completed and the associated data and documentation are available and authorized”

Case “4.10.5 Inspection and Test Records”

Text1.Text= “The supplier shall establish and maintain records which provide evidence that the product has been inspected and/or tested. These records shall show clearly whether the product has passed or failed the inspections and/or tests according to defined acceptance criteria. Where the product fails, to pass any inspection and/or test, the procedures for control of nonconforming product shall apply (see 4.13).” & Chr(13)+Chr(10) & _““& Chr(13)+Chr(10) & _“Records shall identify the inspection authority responsible for the release of product (see 4.16)”

Case “4.11.1 General Control of Inspection, Measuring, and Test Equipment”

Text1.Text= “The supplier shall establish and maintain documented procedures to control, calibrate, and maintain inspection, measuring, and test equipment (including test software) used by the supplier to demonstrate the conformance of product to the specified requirements. Inspection, measuring, and test equipment shall be used in a manner which ensures that the measurement uncertainty is known and is consistent with the required measurement capability” & Chr(13)+Chr(10) & _““& Chr(13)+Chr(10) & _“Where test software or comparative references such as test hardware are used as suitable forms of inspection, they shall be checked to prove that they are capable of verifying the acceptability of product, prior to release for use during production, installation, or servicing, and shall be rechecked at prescribed intervals. The supplier shall establish the extent and frequency of such checks and shall maintain records as evidence of control (see 4.16).” & Chr(13)+Chr(10) & _““& Chr(13)+Chr(10) & _“Where the availability of technical data pertaining to the measurement equipment is a specified requirement, such data shall be made available, when required by the customer or customer's representative, for verification that the measuring equipment is functionally adequate.” & Chr913)+Chr(10) & _““& Chr(13)+Chr(10) & _

“NOTE 17: For the purposes of this American National Standard, the term measuring equipment'includes measurement devices”

Case “4.11.2 Control Procedure”

Text1.Text= “The supplier shall:” & Chr913)+Chr(10) &

“a) determine the measurements to be made an@ the accuracy required, and select the appropriate inspection, measuring, and test equipment that is capable of the necessary accuracy and precision;” & Chr(13)+Chr(10) & _

“b) identify all inspection, measuring, and test equipment that can affect product quality, and calibrate and adjust them at prescribed intervals, or prior to use, against certified equipment having a known valid relationship to internationally or nationally recognized standards. Where no such standards exist, the basis used for calibration shall be documented;” & Chr(13)+Chr(10) & _

“c) define the process employed for the calibration of inspection, measuring, and test equipment, including details of equipment type, unique identification, location, frequency of checks, check method, acceptance criteria, and the action to be taken when results are unsatisfactory;” & Chr(13)+Chr(10) & _

“d) identify inspection, measuring, and test equipment with a suitable indicator or approved identification record to show the calibration status;” & Chr(13)+Chr(10) & _

“e) maintain calibration records for inspection, measuring, and test equipment (see 4.16);” & Chr(13)+Chr(10) & _

“f) assess and document the validity of previous inspection and test results when inspection, measuring, and test equipment is found to be out of calibration;” & Chr(13)+Chr(10) & _

“g) ensure that the environmental conditions are suitable for the calibrations, inspections, measurements, and tests being carried out;” & Chr(13)+Chr(10) & _

“h) ensure that the handling, preservation, and storage of inspection, measuring, and test equipment is such that the accuracy and fitness for use are maintained;” & Chr(13)+Chr(10) & _

“i) safeguard inspection, measuring, and test facilities, including both test hardware and test software, from adjustments which would invalidate the calibration setting.” & Chr913)+Chr(10) & _

“NOTE 18 The metrological confirmation system for measuring equipment given in ISO 10012 may be used for guidance”

Case “4.12 Inspection and Test Status”

Text1.Text= “The inspection and test status of product shall be identified by suitable means, which indicate the confarmance or nonconformance of product with regard to inspection and tests performed. lie identification of inspection and test status shall be maintained, as defined in the quality plan and/or documented procedures, throughout production, installation, and servicing of the product to ensure that only product that has passed the required inspections and tests [or released under an authorized concession (see 4.13.2)] is dispatched, used, or installed”

Case “4.13.1 General Control of Nonconforming Product”

Text1.Text= “The supplier shall establish and maintain documented procedures to ensure that product that does not conform to specified requirements is prevented from unintended use or installation. This control shall provide for identification, documentation, evaluation, segregation (when practical), disposition of nonconforming product, and for notification to the functions concerned”

Case “4.13.2 Review and Disposition of Nonconforming Product”

Text1.Text= “The responsibility for review and authority for the disposition of nonconforming product shall be defined.” & Chr(13)+Chr(10) & _“Nonconforming product shall be reviewed in accordance with documented procedures. It may be” & Chr(13)+Chr(10) & _““& Chr(13)+Chr(10) & _

“a) reworked to meet the specified requirements,” & Chr913)+Chr(10) &

“b) accepted with or without repair by concession,” & Chr(13)+Chr(10) & _

“c) regarded for alternative applications, or” & Chr(13)+Chr(10) & _

“d) rejected or scrapped.” & Chr(13)+Chr(10) & _“Where required by the contract, the proposed use or repair of product (see 4.13.2b) which does not conform to specified requirements shall be reported for concession to the customer or customer's representative. The description of the nonconformity that has been accepted, and of repairs, shall be recorded to denote the actual condition (see 4.16).” & Chr(13)+Chr(10) & _“Repaired and/or reworked product shall be reinspected in accordance with the quality plan and/or documented procedures”

Case “4.14.1 General Corrective and Preventive Action”

Text1.Text= “The supplier shall establish and maintain documented procedures for implementing corrective and preventive action.” & Chr(13)+Chr(10) & _““& Chr(13)+Chr(1 0) & _“Any corrective or preventive action taken to eliminate the causes of actual or potential nonconformities shall be to a degree appropriate to the magnitude of problems and commensurate with the risks encountered.” & Chr(13)+Chr(10) & _““& Chr(13)+Chr(10) & _“The supplier shall implement and record any changes to the documented procedures resulting from corrective and preventive action”

Case “4.14.2 Corrective Action”

Text1.Text= “The procedures for corrective action shall include:” & Chr(13)+Chr(10) & _

“a) the effective handling of customer complaints and reports of product non conformities;” & Chr(13)+Chr(10) & _

“b) investigation of the cause of non conformities relating to product, process, and quality system, and recording the results of the investigation (see 4.16);” & Chr(13)+Chr(10) & _

“c) determination of the corrective action needed to eliminate the cause of non conformities;” & Chr(13)+Chr(10) & _

“d) application of controls to ensure that corrective action is taken and that it is effective”

Case “4.14.3 Preventive Action”

Text1.Text= “The procedures for preventive action shall include:” & Chr(13)+Chr(10) & _““& Chr(13)+Chr(10) & _

“a) the use of appropriate sources of information such as processes and work operations which affect product quality, concessions, audit results, quality records, service reports, and customer complaints to detect, analyze, and eliminate potential causes of nonconformities;” & Chr913)+Chr(10) & ““& Chr(13)+Chr(10) & _

“b) determination of the steps needed to deal with any problems requiring preventive action;” & Chr913)+Chr(10) & _& Chr(13)+Chr(10) & _

“c) initiation of preventive action and application of controls to ensure that it is effective;” & Chr913)+Chr(10) & ” & Chr(13)+Chr(10) & _

“d) ensuring that relevant information on actions taken is submitted for management review (see 4.1.3)”

Case “4.15.1 General Handling, Storage, Packaging, Preservation, and Delivery”

Text1.Text= “The supplier shall establish and maintain documented procedures for handling, storage, packaging, preservation, and delivery of product”

Case “4.15.2 Handling”

Text1.Text= “The supplier shall provide methods of handling product that prevent damage or deterioration”

Case “4.15.3 Storage”

Text1.Text= “The supplier shall use designated storage areas or stock rooms to prevent damage or deterioration of product, pending use or delivery. Appropriate methods for authorizing receipt to and dispatch from such areas shall be stipulated.” & Chr(13)+Chr(10) & _““& Chr(13)+Chr(10) & _“In order to detect deterioration, the condition of product in stock shall be assessed at appropriate intervals”

Case “4.15.4 Packaging”

Text1.Text= “The supplier shall control packing, packaging, and marking processes (including materials used) to the extent necessary to ensure conformance to specified requirements”

Case “4.15.6 Delivery”

Text1.Text= “The supplier shall apply appropriate methods for preservation and segregation of product when the product is under the supplier's control”

Case “4.16 Control of Quality Records”

Text1.Text= “The supplier shall arrange for the protection of the quality of product after final inspection and test. Where contractually specified, this protection shall be extended to include delivery to destination.” & Chr(13)+Chr(10) & _““& Chr(13)+Chr(10) & _Labell.Caption & Chr(13)+Chr(10) & _““& Chr(13)+Chr(10) & _“The supplier shall establish and maintain documented procedures for identification, collection, indexing, access, filing, storage, maintenance, and disposition of quality records. Quality records shall be maintained to demonstrate conformance to specified requirements and the effective operation of the quality system. Pertinent quality records from the subcontractor shall be an element of these data. All quality records shall be legible and shall be stored and retained in such a way that they are readily retrievable in facilities that provide a suitable environment to prevent damage or deterioration and to prevent loss. Retention times of quality records shall be established and recorded. Where agreed contractually, quality records shall be made available for evaluation by the customer or the customer's representative for an agreed period.” & Chr(13)+Chr(10) & _” ” & Chr(13)+Chr(10) & _

“NOTE 19: Records may be in the form of any type of media, such as hard copy or electronic media”

Case “4.17 Internal Quality Audits” Texti.Text= “The supplier shall establish and maintain documented procedures for planning and implementing internal quality audits to verify whether quality activities and related results comply with planned arrangements arid to determine the effectiveness of the quality system. Internal quality audits shall be scheduled on the basis of the status and importance of the activity to be audited and shall be carried out by personnel independent of those having direct responsibility for the activity being audited. The results of the audits shall be recorded (see 4.16) and brought to the attention of the personnel having responsibility in the area audited. The management personnel responsible for the area shall take timely corrective action on deficiencies found during the audit. Follow-up audit activities shall verify and record the implementation and effectiveness of the corrective action taken (see 4.16). NOTES 20 The results of internal quality audits form an integral part of the input to” & _“management review activities (see 4.1.3). 21 Guidance on quality-system audits is given in ANSI/ ISO/ASQC QIOOI 1-1-1994, ANSIASO/ASQC QIOOII2-1994, and ANMSO/ASQC QOOl 1-3-1994”

Case “4.18 Training”

Text1.Text= “The supplier shall establish and maintain documented procedures for identifying training needs and provide for the training of all personnel performing activities affecting quality. Personnel performing specific assigned tasks shall be qualified on the basis of appropriate education, training and/or experience, as required. Appropriate records of training shall be maintained (see 4.16)”

Case “4.19 Servicing”

Text1.Text= “Where servicing is a specified requirement, the supplier shall establish and maintain documented procedures for performing, verifying, and reporting that the servicing meets the specified requirements”

Case “4.20.1 Identification of Need of Statistical Techniques”

Text1.Text= “The supplier shall identify the need for statistical techniques required for establishing, controlling, and verifying process capability and product characteristics”

Case “4.20.2 Procedures of Applications of Statistical Techniques”

Text1.Text= “The supplier shall establish and maintain documented procedures to implement and control the application of the statistical techniques identified in 4.20. 1”

End Select

End Select

Text1.Text = Texttt & Combo1.Text & “” & Chr(13) + Chr(10) & Text1.Text
If Combo1.Text = “Exit” Then

Form2.Hide
Unload Form2

Else

If (Combo1.Text <> “Please use the light grey window bellow to

nevigate” And _{—}

Combo1.Text <> “Click on the right to nevigate”) Then
L = 1
Do Until L = 31
On Error Resume Next
Open Qcdir & “\” & Combo1.Text & “\” & “sub_cat_” & Str(L) & “.txt” For

Input As #L

L = L + 1
Loop
I = 1
Do Until I = 31

Line Input #I, Sub_Cat_Name$(I)
If(I > 10 And I < 21) Then

j = I − 10

Else

```
If(I > 20) Then
  j = I − 20
Else
  j = I
End If
```

End If
Command2(I − 1).Caption = Str(j) &“_”& Mid(Sub_Cat_Name$(I), 4,

8)

I = I + 1

Loop
M = 1
Do Until M = 31

On Error Resume Next
Close #M
M = M + 1

Loop

Else
End If

End If
Label1.Caption = Combo1.Text

End Sub
Private Sub Command2_Click(Index As Integer)
If (Combo1.Text <> “Please use the light grey window bellow to nevigate” And
^{—}Combo1.Text <> “Click on the right to nevigate”) Then

Text2.Text = “The following is the File Builder's Comments on the file your

```
are viewing”
tt$ = “”
On Error GoTo NoFileThere0
Open Qcdir & “\” & Combo1.Text & “\” & “sub_cat_& Str(Index + 1) & “.txt”
For Input As #(Index + 1)
Do Until EOF(Index + 1)
  Line Input #(Index + 1), Line_of_Text$
  tt$ = tt$ & Line_of_Text$ & Wrap$
Loop
Text2.Text = tt$
Close #(Index + 1)
```

If (Index > 9 And Index < 20) Then

j = Index − 9
current_file_name = Qcdir & “\” & Combo1.Text & “\record” & Str(j) &“_” &

Combo1.Text & “.” & Left(Sub_Cat_Name$(Index + 1), 3)

Else

If (Index > 19) Then
j = Index − 19
current_file_name = Qcdir & “\” & Combo1.Text & “\procedure” & Str(j) &

“_” & Combo1.Text & “.” & Left(Sub_Cat_Name$(Index + 1), 3)

Else

```
If (Index < 10) Then
  j = Index + 1
  current_file_name =Qcdir & “\” & Combo1.Text & “\policy”& Str(j) &
```

“_” & Combo1.Text & “.” & Left(Sub_Cat_Name$(Index + 1), 3)

Else
End If

End If

```
  End If
Else
  MsgBox (“Please use the light grey window to choose a file category.”),,“”
  Exit Sub
End If
On Error GoTo NoFileThere0
GetAttr (current_file_name)
  OLE1.CreateLink current_file_name
  OLE1.Action = 7
  Exit Sub
NoFileThere0:
MsgBox (“File does not exist in the structure”),,_{—}
```

“Please Click OK to continue”
Exit Sub

```
End Sub
Private Sub Dir1_Change()
  Qcdir = Dir1.Path
End Sub
Private Sub Drive1_Change()
  On Error GoTo No_drive_1
  Dir1.Path = Drive1.Drive
  Exit Sub
No_drive_1:
MsgBox (“Please load disk and then retry.”),, “”
Exit Sub
End Sub
```

VERSION 5.00

```
AutoRedraw = 1 ′True
BackColor = &H00404040&
BorderStyle = 0 ′None
Caption = “Quality Systems Administrator”
ClientHeight = 6765
ClientLeft = 0
ClientTop = 0
ClientWidth = 8385
FillStyle = 0 ′Solid
FontTransparent = 0 ′False
Icon = “cover.frx”:0000
LinkTopic = “Form3”
MaxButton = 0 ′False
MmButton = 0 ′False
ScaleHeight = 6765
ScaleWidth = 8385
ShowInTaskbar = 0 ′False
StartUpPosition = 2 ′CenterScreen
Begin VB.Label Label3
  Appearance = 0 ′Flat
  AutoSize = −1 ′True
  BackColor = &H80000000&
  BackStyle = 0 ′Transparent
  Caption = “Xueshu Song and Clifford Mirman”
  ForeColor = &H0000FFFF&
  Height = 195
  Index = 2
  Left = 2760
  TabIndex = 3
  Top = 6000
  Width = 2355
End
Begin VB.Label Label3
  Appearance = 0 ′Flat
  AutoSize = −1 ′True
  BackColor = &H80000000&
  BackStyle = 0 ′Transparent
  Caption = “Developed by”
  ForeColor = &H0000FFFF&
  Height = 195
  Index = 0
  Left = 3480
  Tabindex = 2
  Top = 5760
  Width = 990
End
Begin VB.Image Image1
  Height = 3915
  Left = 1920
  Mouselcon = “cover.frx”:0152
  MousePointer = 4 ′Icon
  Picture = “cover.frx”:02A4
  Stretch = −1 ′True
  ToolTipText = “Click to Continue”
  Top = 1320
  Width = 4065
End
Begin VB.Label Label1
  BackStyle = 0 ′Transparent
  Caption = “Version 1.0.0”
  BeginProperty Font
    Name = “MS Sans Serif”
    Size = 13.5
    Charset = 0
    Weight = 700
    Underline = 0 ′False
    Italic = −1 ′True
    Strikethrough = 0 ′False
  End Property
  ForeColor = &H0000FFFF&
  Height = 495
  Index = 1
  Left = 2880
  TabIndex = 1
  Top = 960
  Width = 2175
End
Begin VB.Label Label1
  BackStyle = 0 ′Transparent
  Caption = “Quality Systems Viewer”
  BeginProperty Font
    Name = “MS Sans Serif”
    Size = 24
    Charset = 0
    Weight = 700
    Underline = 0 ′False
    Italic = −1 ′True
    Strikethrough = 0 ′False
  End Property
  ForeColor = &H0000FFFF&
  Height = 735
  Index = 0
  Left = 1320
  TabIndex = 0
  Top = 360
  Width = 6015
End
```

Throughout this application, various publications, including United States patents, are referenced by author and year and by patent number. Full citations for the publications are listed below. The disclosures of these publications and patents in their entireties are hereby incorporated by reference into this application in order to describe more fully the state of the art to which this invention pertains.

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. A compiling wizard comprising:
storage and creation means for compiling information into various accessible formats; and
user viewer means for viewing and accessing said compiled information.

2. The compiling wizard according to claim 1, further including sorting means for sorting information into various sub-categories.

3. The compiling wizard according to claim 1 including standardized file naming means for naming files.

4. The compiling wizard according to claim 1 including tracking means for naming, traversing, updating, and archiving said compiled and entered information into accessible files of variable formats.

5. The compiling wizard according to claim 1 including security means for restricting access to said information.

6. The compiling wizard according to claim 1, wherein said information is selected from the group consisting essentially of text data, documents, audio media, video media, image media, and graphics.

7. A software program for controlling and operating a compiling wizard that includes storage and creation means for compiling information into various accessible formats, and user viewer means for viewing and accessing the compiled information.

8. The software program according to claim 7, being accessible through communication systems selected from the group consisting essentially of the Internet, Intranet, Extranet, and electronically.

9. The software program according to claim 7 including a source code for encoding functions of the software program.

10. The software program according to claim 7 including security means for restricting access to the software program.
